(19) United States
(12) Patent Application Publication
(10) Pub. No.: US 2017/0111887 A1
(43) Pub. Date: Apr. 20, 2017

(54) APPARATUS AND METHOD FOR CONTROLLING OPERATION OF USER EQUIPMENT BASED ON INTERFERENCE CHARACTERISTIC IN COMMUNICATION SYSTEM

(71) Applicant: Samsung Electronics Co., Ltd, Gyeonggi-do (KR)

(72) Inventors: Sung-Nam Hong, Gyeonggi-do (KR); Ji-Yun Seol, Gyeonggi-do (KR); Tae-Young Kim, Seoul (KR)

(21) Appl. No.: 15/294,634

(22) Filed: Oct. 14, 2016

(30) Foreign Application Priority Data
Oct. 16, 2015 (KR) 10-2015-0144867

(51) Int. Cl. H04W 72/04; H04W 24/02; H04L 5/00; H04B 17/345; H04L 1/00

(52) U.S. Cl. CPC H04W 72/042; H04B 17/345; H04L 1/0009; H04L 5/0032; H04L 1/0013; H04W 24/02

(57) ABSTRACT

The present disclosure relates to a pre-5th-generation (5G) or 5G communication system to be provided for supporting higher data rates beyond 4th-generation (4G) communication system such as a long term evolution (LTE). An operating method of a user equipment (UE) in a communication system includes transmitting, to an evolved node B (eNB), information related to channel quality, information related to a reception (Rx) scheme which the UE is able to apply, and information related to an interference environment characteristic, and receiving, from the eNB, information related to a modulation and coding scheme (MCS) to be applied in the UE.

### CROSS-REFERENCE TO RELATED APPLICATION(S) AND CLAIM OF PRIORITY

The present application is related to and claims the benefit under 35 U.S.C. §119(a) of a Korean patent application filed on Oct. 16, 2015 in the Korean Intellectual Property Office and assigned Serial No. 10-2015-0144867, the entire disclosure of which is incorporated herein by reference.

### TECHNICAL FIELD

The present disclosure relates to an apparatus and method for controlling an operation of a user equipment (UE) in a communication system, and more particularly, to an apparatus and method for controlling an operation of a UE based on an interference characteristic in a communication system.

### BACKGROUND

To meet the demand for wireless data traffic, which has increased since deployment of 4th-generation (4G) communication systems, efforts have been made to develop an improved 5th-generation (5G) or pre-5G communication system. Therefore, the 5G or pre-5G communication system is also called a ‘beyond 4G network’ or a ‘post long-term evolution (LTE) system’.

It is considered that the 5G communication system will be implemented in millimeter wave (mmWave) bands, e.g., 60 GHz bands, so as to accomplish higher data rates. To reduce propagation loss of radio waves and increase a transmission distance, a beam forming technique, a massive multiple-input multiple-output (MIMO) technique, a full dimensional MIMO (FD-MIMO) technique, an array antenna technique, an analog beam forming technique, and a large scale antenna technique are discussed in 5G communication systems.

In addition, in 5G communication systems, development for system network improvement is under way based on advanced small cells, cloud radio access networks (RANs), ultra-dense networks, a device-to-device (D2D) communication, a wireless backhaul, a moving network, a cooperative communication, coordinated multi-points (CoMP), reception-end interference cancellation, and the like.

In the 5G system, a hybrid frequency shift keying (FSK) and quadrature amplitude modulation (QAM) modulation (FQAM) and a sliding window superposition coding (SWSC) as an advanced coding modulation (ACM) scheme, and a filter bank multi carrier (FBMC) scheme, a non-orthogonal multiple Access (NOMA) scheme, and a sparse code multiple access (SCMA) scheme as an advanced access technology have been developed.

So, there is a need for a scheme of controlling an operation of a UE based on an Rx scheme which is applied to the UE, e.g., a Gaussian Rx scheme and a non-Gaussian Rx scheme.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object to provide an apparatus and method for controlling an operation of a UE based on an interference characteristic in a communication system.

Another aspect of the present disclosure is to propose an apparatus and method for controlling an operation of a UE to be suitable for a channel state based on an interference characteristic in a communication system.

Another aspect of the present disclosure is to propose an apparatus and method for controlling an operation of a UE based on an interference characteristic thereby applying an MCS level in a communication system.

Another aspect of the present disclosure is to propose an apparatus and method for controlling an operation of a UE based on an interference characteristic thereby satisfying a target BLER in a communication system.

Another aspect of the present disclosure is to propose an apparatus and method for controlling an operation of a UE based on an interference characteristic thereby increasing a data rate in a communication system.

Another aspect of the present disclosure is to propose an apparatus and method for controlling an operation of a UE based on an interference characteristic thereby increasing throughput in a communication system.

In accordance with an aspect of the present disclosure, an operating method of a user equipment (UE) in a communication system is provided. The operating method includes transmitting, to an evolved node B (eNB), information related to channel quality, information related to a reception (Rx) scheme which the UE is able to apply, and information related to an interference environment characteristic; and receiving, from the eNB, information related to a modulation and coding scheme (MCS) to be applied in the UE.

In accordance with another aspect of the present disclosure, an operating method of an evolved node B (eNB) in a communication system is provided. The operating method includes receiving, from a user equipment (UE), information related to channel quality, information related to a reception (Rx) scheme which the UE is able to apply, and information related to an interference environment characteristic, determining information related to a modulation and coding scheme (MCS) to be applied in the UE based on the received information; and transmitting, to the UE, information related to the MCS to be applied in the UE.

In accordance with another aspect of the present disclosure, an operating method of a user equipment (UE) in a communication system is provided. The operating method includes transmitting, to an evolved node B (eNB) at first time, information related to channel quality, information related to a reception (Rx) scheme which the UE is able to apply, and information related to an interference environment characteristic, receiving, from the eNB, information related to a modulation and coding scheme (MCS) to be applied in the UE, information related to an Rx scheme to be applied in the UE, and information related to an interference environment characteristic which the UE needs to report, and transmitting, to the eNB at second time, information related to channel quality, information related to a reception Rx scheme which the UE is able to apply, and information related to an interference signal with maximum strength.

In accordance with another aspect of the present disclosure, an operating method of an evolved node B (eNB) in a communication system is provided. The operating method includes receiving, from a user equipment (UE) at first time, information related to channel quality, information related to a reception (Rx) scheme which the UE is able to apply, and information related to an interference environment characteristic, determining information related to a modulation and coding scheme (MCS) to be applied in the UE, information related to an Rx scheme to be applied in the UE, and information related to an interference environment characteristic which the UE needs to report based on the received information, and transmitting, to the UE, the information related to the MCS to be applied in the UE, the information related to the Rx scheme to be applied in the UE, and the information related to the interference environment characteristic which the UE needs to report.

In accordance with another aspect of the present disclosure, a user equipment (UE) in a communication system is provided. The UE includes a transmitter configured to transmit, to an evolved node B (eNB), information related to channel quality, information related to a reception (Rx) scheme which the UE is able to apply, and information related to an interference environment characteristic; and a receiver configured to receive, from the eNB, information related to a modulation and coding scheme (MCS) to be applied in the UE.

In accordance with another aspect of the present disclosure, an evolved node B (eNB) in a communication system is provided. The eNB includes a receiver configured to receive, from a user equipment (UE), information related to channel quality, information related to a reception (Rx) scheme which the UE is able to apply, and information related to an interference environment characteristic; a controller configured to perform an operation of determining information related to a modulation and coding scheme (MCS) to be applied in the UE based on the received information; and a transmitter configured to transmit, to the UE, information related to the MCS to be applied in the UE.

In accordance with another aspect of the present disclosure, a user equipment (UE) in a communication system is provided. The UE includes a transmitter configured to transmit, to an evolved node B (eNB) at first time, information related to channel quality, information related to a reception (Rx) scheme which the UE is able to apply, and information related to an interference environment characteristic, and a receiver configured to receive, from the eNB, information related to a modulation and coding scheme (MCS) to be applied in the UE, information related to an Rx scheme to be applied in the UE, and information related to an interference environment characteristic which the UE needs to report, wherein the transmitter transmits, to the eNB at second time, information related to channel quality, information related to a reception Rx scheme which the UE is able to apply, and information related to an interference signal with maximum strength.

In accordance with another aspect of the present disclosure, an evolved node B (eNB) in a communication system is provided. The eNB includes a receiver configured to receive, from a user equipment (UE) at first time, information related to channel quality, information related to a reception (Rx) scheme which the UE is able to apply, and information related to an interference environment characteristic; a controller configured to determine information related to a modulation and coding scheme (MCS) to be applied in the UE, information related to an Rx scheme to be applied in the UE, and information related to an interference environment characteristic which the UE needs to report based on the received information, and a transmitter configured to transmit, to the UE, the information related to the MCS to be applied in the UE, the information related to the Rx scheme to be applied in the UE, and the information related to the interference environment characteristic which the UE needs to report.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates a signal transmitting/receiving process between an eNB and a UE for controlling an operation of the UE in a communication system;

FIGS. 2A to 2C schematically illustrate BLER performance according to an interference channel environment in a case that a Gaussian Rx scheme is used and BLER performance according to an interference channel environment in a case that a non-Gaussian Rx scheme is used in a wireless communication system;

FIG. 3 schematically illustrates a signal transmitting/receiving process between an eNB and a UE for controlling an operation of the UE in a communication system according to an embodiment of the present disclosure;

FIG. 4 schematically illustrates a signal transmitting/receiving process between an eNB and a UE according to a link adaptation scheme in a communication system according to an embodiment of the present disclosure;

FIG. 5 schematically illustrates a process of performing a link adaptation scheme in an eNB in a communication system according to an embodiment of the present disclosure;

FIG. 6 schematically illustrates a process of estimating an effective SINR based on a received power level and an RB hitting rate of a dominant interference (DI) signal in an eNB in a communication system according to an embodiment of the present disclosure;

FIG. 7 schematically illustrates an ISC operation according to an ISC scheme in a communication system according to an embodiment of the present disclosure;

FIG. 8 schematically illustrates a signal transmitting/receiving process between an eNB and a UE according to an ISC scheme in a communication system according to an embodiment of the present disclosure;

FIG. 9 schematically illustrates a process of performing an ISC operation in an eNB in a communication system according to an embodiment of the present disclosure;

FIG. 10 schematically illustrates a signal transmitting/receiving process between an eNB and a UE according to an SPIORxS in a communication system according to an embodiment of the present disclosure;

FIG. 11 schematically illustrates an inner structure of an eNB in a communication system according to an embodiment of the present disclosure; and

FIG. 12 schematically illustrates an inner structure of a UE in a communication system according to an embodiment of the present disclosure.

Throughout the drawings, it should be noted that like reference numbers are used to depict the same or similar elements, features, and structures.

### DETAILED DESCRIPTION

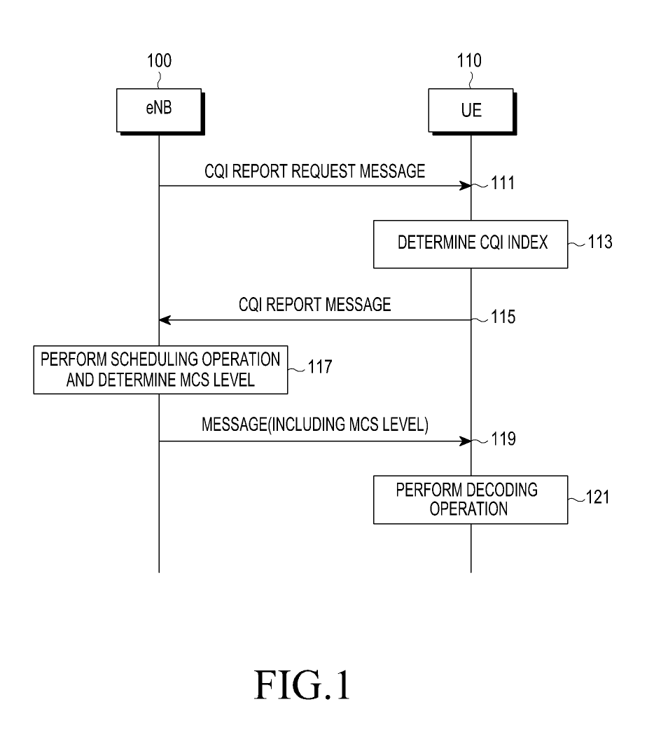

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged telecommunication devices.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as “first,” “second,” and so forth will be used to describe various components, those components are not limited herein. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing various embodiments only and is not intended to be limiting. As used herein, the singular forms are intended to include the plural forms as well, unless the context clearly indicates otherwise. It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology.

According to various embodiments of the present disclosure, an electronic device may include communication functionality. For example, an electronic device may be a smart phone, a tablet personal computer (PC), a mobile phone, a video phone, an e-book reader, a desktop PC, a laptop PC, a netbook PC, a personal digital assistant (PDA), a portable multimedia player (PMP), an mp3 player, a mobile medical device, a camera, a wearable device (e.g., a head-mounted device (HIVID), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a digital video disk (DVD) player, an audio, a refrigerator, an air conditioner, a vacuum cleaner, an oven, a microwave oven, a washer, a dryer, an air purifier, a set-top box, a TV box (e.g., Samsung HomeSync®, Apple TV®, or Google TV®), a gaming console, an electronic dictionary, an electronic key, a camcorder, an electronic picture frame, and/or the like.

According to various embodiments of the present disclosure, an electronic device may be a medical device (e.g., magnetic resonance angiography (MRA) device, a magnetic resonance imaging (MRI) device, computed tomography (CT) device, an imaging device, or an ultrasonic device), a navigation device, a global positioning system (GPS) receiver, an event data recorder (EDR), a flight data recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

According to various embodiments of the present disclosure, for example, a transmitting apparatus or a receiving apparatus may be a user equipment (UE).

According to various embodiments of the present disclosure, for example, a transmitting apparatus or a receiving apparatus may be an evolved node B (eNB).

In various embodiments of the present disclosure, it will be noted that the term UE may be interchangeable with the term mobile station (MS), wireless terminal, mobile device, and/or the like.

In various embodiments of the present disclosure, it will be noted that the term eNB may be interchangeable with the term access point (AP), base station (BS), and/or the like.

An embodiment of the present disclosure provides an apparatus and method for controlling an operation of a UE based on an interference characteristic in a communication system.

An embodiment of the present disclosure provides an apparatus and method for controlling an operation of a UE to be suitable for a channel state based on an interference characteristic in a communication system.

An embodiment of the present disclosure provides an apparatus and method for controlling an operation of a UE based on an interference characteristic thereby applying an optimal modulation and coding scheme (MCS) level in a communication system.

An embodiment of the present disclosure provides an apparatus and method for controlling an operation of a UE based on an interference characteristic thereby satisfying a target block error rate (BLER) in a communication system.

An embodiment of the present disclosure provides an apparatus and method for controlling an operation of a UE based on an interference characteristic thereby increasing a data rate in a communication system.

An embodiment of the present disclosure provides an apparatus and method for controlling an operation of a UE based on an interference characteristic thereby increasing throughput in a communication system.

An apparatus and method proposed in various embodiments of the present disclosure may be applied to various communication systems such as a long term evolution (LTE) mobile communication system, an LTE-advanced (LTE-A) mobile communication system, a licensed-assisted access (LAA)-LTE mobile communication system, a high speed downlink packet access (HSDPA) mobile communication system, a high speed uplink packet access (HSDPA) mobile communication system, a high rate packet data (HRPD) mobile communication system proposed in a 3rdgeneration project partnership 2 (3GPP2), a wideband code division multiple access (WCDMA) mobile communication system proposed in the 3GPP2, a code division multiple access (CDMA) mobile communication system proposed in the 3GPP2, an institute of electrical and electronics engineers (IEEE) 802.16m communication system, an IEEE 802.16e communication system, an evolved packet system (EPS), and a mobile internet protocol (Mobile IP) system, a digital video broadcast system such as a mobile broadcast service such as a digital multimedia broadcasting (DMB) service, a digital video broadcasting-handheld (DVP-H), an advanced television systems committee-mobile/handheld (ATSC-M/H) service, and the like, and an internet protocol television (IPTV), a moving picture experts group (MPEG) media transport (MMT) system and/or the like.

A signal transmitting/receiving process between an evolved node B (eNB) and a UE for controlling an operation of the UE in a general communication system will be described with reference to FIG. 1.

FIG. 1 schematically illustrates a signal transmitting/receiving process between an eNB and a UE for controlling an operation of the UE in a communication system.

Referring to FIG. 1, the communication system includes an eNB 100 and a UE 110.

The eNB 100 transmits a channel quality indicator (CQI) report request message to the UE 110 at operation 111. After receiving the CQI report request message from the eNB 100, the UE 110 calculates an effective signal-to-interference noise ratio (SINR) based on a fading channel estimation value of a received signal, and determines a CQI index based on the calculated effective SINR at operation 113. The UE 110 transmits a CQI report message including the CQI index to the eNB 100 at operation 115.

In FIG. 1, the UE 110 transmits the CQI report message to the eNB 100 according to the request of the eNB 100, i.e., according to the reception of the CQI report request message from the eNB 100. However, the UE 110 may periodically or aperiodically transmit the CQI report message to the eNB 100 without receiving the CQI report request message from the eNB 100.

After receiving the CQI report message from the UE 110, the eNB 100 performs a scheduling operation for the UE 110 based on the CQI index included in the CQI report message, and determines an modulation and coding scheme (MCS) level to be applied to the UE 110 at operation 117. The eNB 100 transmits a message including the determined MCS level to the UE 110 at operation 119. After receiving the message including the MCS level from the eNB 100, the UE 110 performs a decoding operation on a received signal based on the MCS level at operation 121.

Meanwhile, inter-cell interference (ICI) in a downlink/uplink of a communication system supporting an orthogonal frequency division multiple access (OFDMA) scheme may significantly degrade performance of a signal receiving apparatus. In a case that a reference signal, e.g., a pilot signal which the signal receiving apparatus uses for estimating a channel or measuring a channel is distorted due to the ICI, the performance of the signal receiving apparatus may be significantly degraded.

So, most communication standards supporting an OFDMA scheme such as an LTE, and/or the like use various schemes, e.g., a scheme of differently setting a location of a reference signal used in each of cells, a scheme of setting large power applied to a reference signal compared to power applied to a data signal, e.g., a data symbol, i.e., a scheme of boosting the power applied to the reference signal compared the power applied to the data signal, and/or the like.

For example, in a downlink of an LTE mobile communication system, it is defined that neighbor eNBs shift cell-specific reference signals (CRSs) in a frequency axis in a specific CRS based on different offsets to transmit the shifted CRSs, and each eNB boosts power of a CRS using transmission (Tx) power larger than Tx power applied to a data signal to transmit the power boosted CRS.

The schemes described above may decrease distortion of a reference signal due to ICI, so severe degradation of channel estimation performance and channel estimation performance in a signal receiving apparatus may be prevented.

However, the power boosted reference signal described above is acted as ICI to a data signal included in a target signal, so a non-Gaussian characteristic of an interference signal occurs.

Generally, in a case that a Gaussian reception (Rx) scheme, i.e., an Rx scheme which is based on a Gaussian characteristic is applied, block error rate (BLER) performances of UEs are similar if SINRs of the UEs are similar.

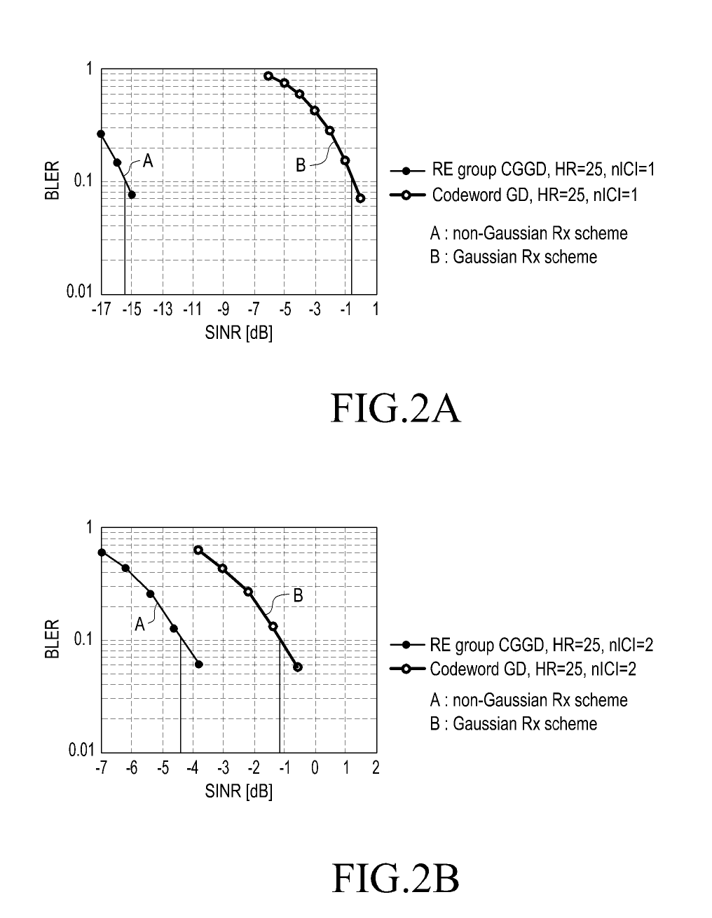

However, in a case that a non-Gaussian Rx scheme, i.e., an Rx scheme which is based on a non-Gaussian characteristic is applied, BLER performances of UEs may be significantly different according to an interference channel environment even though SINRs of the UEs are similar. This will be described with reference to FIGS. 2A to 2C.

FIGS. 2A to 2C schematically illustrate BLER performance according to an interference channel environment in a case that a Gaussian Rx scheme is used and BLER performance according to an interference channel environment in a case that a non-Gaussian Rx scheme is used in a wireless communication system.

Referring to FIG. 2A, BLER performance according to an interference channel environment when a Gaussian Rx scheme is used and BLER performance according to an interference channel environment when a non-Gaussian Rx scheme is used in FIG. 2A indicate BLER performance according to an interference channel environment when a Gaussian Rx scheme is used and BLER performance according to an interference channel environment when a non-Gaussian Rx scheme is used in a case that there is one interference eNB, and a resource block (RB) hitting rate is 25%.

Referring to FIG. 2B, BLER performance according to an interference channel environment when a Gaussian Rx scheme is used and BLER performance according to an interference channel environment when a non-Gaussian Rx scheme is used in FIG. 2B indicate BLER performance according to an interference channel environment when a Gaussian Rx scheme is used and BLER performance according to an interference channel environment when a non-Gaussian Rx scheme is used in a case that there are two interference eNBs, and an RB hitting ratio is 25%.

Referring to FIG. 2C, BLER performance according to an interference channel environment when a Gaussian Rx scheme is used and BLER performance according to an interference channel environment when a non-Gaussian Rx scheme is used in FIG. 2C indicate BLER performance according to an interference channel environment when a Gaussian Rx scheme is used and BLER performance according to an interference channel environment when a non-Gaussian Rx scheme is used in a case that there is one interference eNB, and an RB hitting ratio is 100%.

As shown in FIGS. 2A to 2C, in a case that a Gaussian Rx scheme is used, it will be understood that BLER performances of UEs are similar if SINRs of the UEs are similar.

Further, as shown in FIGS. 2A to 2C, in a case that a non-Gaussian Rx scheme is used, it will be understood that BLER performances of UEs are significantly different even though SINRs of the UEs are similar.

Meanwhile, a process of controlling an operation of a UE in FIG. 1 is a process of controlling an operation of a UE which is suitable for a UE to which a Gaussian Rx scheme is applied.

In a case that a process of controlling an operation of a UE which is suitable for a UE to which a Gaussian Rx scheme is applied is applied to a UE to which a non-Gaussian Rx scheme is applied, the UE to which the non-Gaussian Rx scheme is applied may acquire good BLER performance compared to the UE to which the Gaussian Rx scheme is applied under a given interference channel environment. However, a probability that the acquired BLER is very lower than a target BLER is very high, so it is not preferable that a process of controlling an operation of a UE which is suitable for a UE to which a Gaussian Rx scheme is applied in FIG. 1 is applied to a UE to which a non-Gaussian Rx scheme is applied.

For example, an interference characteristic considered in an embodiment of the present disclosure includes a Gaussian characteristic and a non-Gaussian characteristic. So, an embodiment of the present disclosure controls an operation of a UE based on a Gaussian reception (Rx) scheme, i.e., an Rx scheme which is based on a Gaussian characteristic and a non-Gaussian Rx scheme, i.e., an Rx scheme which is based on a non-Gaussian characteristic, and this will be described below.

A scheme of controlling an operation of a UE proposed in an embodiment of the present disclosure includes a scheme of optimizing a transmitting operation and a scheme of optimizing a receiving operation. For convenience, a scheme of optimizing a transmitting operation will be referred to as “scheme of optimizing transmitting operation (SOTO)”, and a scheme of optimizing a receiving operation will be referred to as “scheme of optimizing receiving operation (SORO)”.

The SOTO is performed based on information fed back from a UE, and the SORO is performed based on information fed forward by an eNB.

The SOTO includes a link adaptation scheme and an interference signal coordination (ISC) scheme, and the SORO includes a scheme of predicting and indicating optimal receiving scheme (SPIORxS). Each of the link adaptation scheme, the ISC scheme, and the SPIORxS will be described below.

Firstly, the link adaptation scheme will be described below.

The link adaptation scheme is a link adaptation scheme for increasing performance of a UE to which a non-Gaussian Rx scheme is applied.

A UE to which the non-Gaussian Rx scheme is applied determines a channel quality indicator (CQI) index based on an effective signal-to-interference noise ratio (SINR) like in as a UE to which a Gaussian Rx scheme is applied, and transmits the determined CQI index to an eNB. The UE reports information related to an Rx scheme which the UE can apply along with the CQI index to the eNB. The UE can apply a non-Gaussian Rx scheme, so the UE reports, to the eNB, information related to an interference environment characteristic which the UE experiences.

The eNB determines an MCS level to be applied to the UE based on the information reported by the UE, i.e., the CQI index, the information related to the Rx scheme which the UE can apply, and the information related to the interference environment characteristic. For example, the determined MCS level can be an optimal MCS level which can maximize performance of the UE.

Secondly, the ISC scheme will be described below.

A UE reports information related to an Rx scheme which the UE can apply to an eNB. If the UE is able to apply a non-Gaussian Rx scheme, the UE reports information related to an interference environment characteristic which the UE experiences to the eNB.

The eNB shares relative narrowband transmission power (RNTP), an overload indicator (OI) and/or the like with interference eNBs through a backhaul. The eNB shares information related to an Rx scheme which can be applied to the UE, i.e., a scheduled UE with the interference eNBs through the backhaul.

The eNB performs an ISC operation which is optimized for an Rx scheme, e.g., a Gaussian Rx scheme or a non-Gaussian Rx scheme based on the information as described above.

Thirdly, the SPIORxS will be described below.

An eNB predicts an interference environment of a UE, and determines an Rx scheme which the UE needs to apply, e.g., an optimal Rx scheme based on the predicted interference environment. In an embodiment of the present disclosure, the Rx scheme which the UE needs to apply is the optimal Rx scheme, however, the Rx scheme which the UE needs to apply can be any Rx scheme appropriate for the UE as well as the optimal Rx scheme.

Meanwhile, the UE reports information related to a Rx scheme which the UE can apply to an eNB. If the UE is able to apply a non-Gaussian Rx scheme, the UE reports information related to an interference environment characteristic which the UE experiences to the eNB.

The eNB can predict an interference environment characteristic which the UE will experience based on the information reported by the UE, and determines an Rx scheme which the UE will apply, e.g., an optimal Rx scheme based on the predicted interference environment characteristic information. The eNB transmits information related to the determined optimal Rx scheme to the UE.

If the link adaptation scheme, the ISC scheme, and the SPIORxS are used, complexity and power consumption of the UE can be decreased.

A signal transmitting/receiving process between an eNB and a UE for controlling an operation of the UE in a communication system according to an embodiment of the present disclosure will be described below.

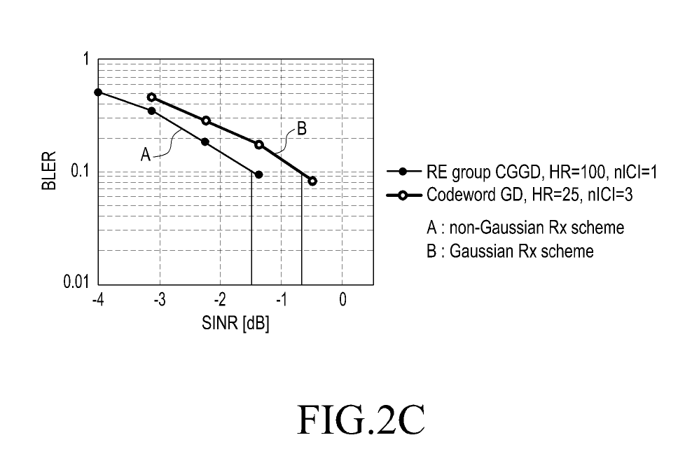

FIG. 3 schematically illustrates a signal transmitting/receiving process between an eNB and a UE for controlling an operation of the UE in a communication system according to an embodiment of the present disclosure.

Referring to FIG. 3, the communication system includes an eNB 300 and a UE 310.

The eNB 300 transmits a report request message to the UE 310 at operation 311. The report request message denotes a message for requesting to report a CQI, information related to an Rx scheme, and information related to an interference environment characteristic. The report request message can be implemented with various forms, and a detailed description thereof will be omitted herein.

After receiving the report request message from the eNB 300, the UE 310 calculates an effective SINR based on a fading channel estimation value of a received signal, and determines a CQI index based on the calculated effective SINR. The UE 310 determines information related to an Rx scheme which the UE 310 applies, e.g., information related to whether the UE 310 is able to apply a non-Gaussian Rx scheme, and estimates information related to an interference environment characteristic which the UE 310 experiences at operation 313. The information related to the interference environment characteristic can include a cell identifier (ID) of a dominant interference (DI) signal, an interference-to-noise ratio (INR), a resource block (RB) hitting rate, and/or the like. Here, an RB includes at least one resource element (RE). The RE is a unit resource, and can be implemented with various forms. A RE group includes at least two REs, so an RE group can be an RB.

Information included in a report message will be described below.

Firstly, the report message can include information related to an Rx scheme, and the information related to the Rx scheme will be described below.

For example, the information related to the Rx scheme can be implemented with two bits. In this case, the two bits can indicate the followings.

If a value of the two bits is ‘00’, it means that a UE can apply only a Gaussian Rx scheme. If a value of the two bits is ‘01’, it means that a UE can apply only a non-Gaussian Rx scheme. If a value of the two bits is ‘10’, it means that a UE can apply both a Gaussian Rx scheme and a non-Gaussian Rx scheme. If a value of the two bits is ‘11’, it means that the two bits are reserved for future use.

Secondly, the report message can include information related to whether a UE is able to apply an interference cancellation (IC) scheme and an interference suppression (IS) scheme. Alternatively, the information related to the Rx scheme can be implicitly informed through a parameter, e.g., naics-Capability-List-r12 used in a communication system, e.g., an LTE communication system, so it will be noted that the information related to whether the UE is able to apply the IC scheme and the IS scheme can be included in the report message if necessary.

Thirdly, the report message can include information related to the number of DI signals to which UE is able to apply an IC scheme and an IS scheme.

The information related to the number of DI signals to which UE is able to apply the IC scheme and the IS scheme can be implemented with two bits. In this case, the two bits can indicate the followings.

If a value of the two bits is ‘00’, it means that a UE is unable to apply an IC scheme and an IS scheme. Alternatively, if a value of the two bits is ‘00’, it means that the two bits are reserved for future use.

If a value of the two bits is ‘01’, it means that a UE is able to apply an IC scheme and an IS scheme to the first DI. If a value of the two bits is ‘10’, it means that a UE is able to apply an IC scheme and an IS scheme to the first DI and the second DI. If a value of the two bits is ‘11’, it means that a UE is able to apply an IC scheme and an IS scheme to the first DI, the second DI, and the third DI.

Information related to an Rx scheme of a UE, information related to whether a UE is able to apply an IC scheme and an IS scheme, and information related to the number of DIs to which a UE is able to apply an IC scheme and an IS scheme can be fed back to an eNB through the report message. For example, the report message can be included in physical layer parameters among UE-EUTRA-Capability as UE radio access capability parameters among radio resource control (RRC) signals used in the LTE communication system.

In the current LTE communication system, the physical layer parameters include parameters informing whether a specific function is supported in a UE. For example, the physical layer parameters include ue-TxAntennaSelectionSupported as a parameter indicating whether a UE supports transmission (Tx) antenna selection, and an enhanced-4TxCodebook-r12 as a parameter indicating whether a UE supports an enhanced 4 Tx codebook.

So, information related to an Rx scheme of a UE, information related to whether a UE is able to apply an IC scheme and an IS scheme, and information related to the number of DIs to which a UE is able to apply an IC scheme and an IS scheme can be included in, for example, the physical layer parameters.

The report message can include information used for the eNB to detect eNBs with which the eNB can cooperate. For example, the information used for detecting the eNBs with which the eNB can cooperate can include a cell ID of a DI signal.

In the current LTE communication system, information about up to eight neighbor cells is converted into an index, and the index indicating the information about up to eight neighbor cells can be fed back. So, in an embodiment of the present disclosure, information related to a cell ID of a DI signal is transmitted using a scheme of converting information about up to eight neighbor cells into an index used in the LTE communication system and feeding back the index indicating the information about up to eight neighbor cells without feeding back the cell ID of the DI signal. In this case, i.e., in a case that a cell ID of a DI signal is converted into an index and the index indicating the cell ID of the DI signal is fed back instead of feeding back the cell ID of the DI signal, overhead can be decreased compared to a case that the cell ID of the DI signal is fed back, and this will be described below.

If information related to the cell ID of the DI signal is expressed with three bits, values expressed with the three bits, i.e., eight values can indicate the followings.

(1) 000: the first NeighCellsInfo-r12 element of NeighCellsToAddModList-r12

(2) 001: the second NeighCellsInfo-r12 element of NeighCellsToAddModList-r12

(3) 010: the third NeighCellsInfo-r12 element of NeighCellsToAddModList-r12

(4) 011: the fourth NeighCellsInfo-r12 element of NeighCellsToAddModList-r12

(5) 100: the fifth NeighCellsInfo-r12 element of NeighCellsToAddModList-r12

(6) 101: the sixth NeighCellsInfo-r12 element of NeighCellsToAddModList-r12

(7) 110: the seventh NeighCellsInfo-r12 element of NeighCellsToAddModList-r12

(8) 111: the eighth NeighCellsInfo-r12 element of NeighCellsToAddModList-r12

Received signal strength of an interference signal can be detected based on an order of feeding back the index.

For example, it will be assumed that the index has been fed back like as “000 010 110”. In this case, the fed back indexes indicate that a cell ID of the first DI signal indicates PhysCellId of the first NeighCellsInfo-r12 of NeighCellsToAddModList-r12, a cell ID of the second DI signal indicates PhysCellId of the third NeighCellsInfo-r12 of NeighCellsToAddModList-r12, and a cell ID of the third DI signal indicates PhysCellId of the seventh NeighCellsInfo-r12 of NeighCellsToAddModList-r12.

Information used for an eNB to detect eNBs with which the eNB can cooperate proposed in an embodiment of the present disclosure, e.g., a cell ID of a DI signal can be fed back to the eNB through the report message. For example, the report message can be included in a physical uplink control channel (PUCCH) format used in the LTE communication system. For example, the report message can be included in a PUCCH format 2 defined for reporting channel status information (CSI), and the PUCCH format 2 is implemented with, for example, eleven bits.

In the above description, the report message is fed back through one of PUCCH formats, e.g., a PUCCH format 2 implemented in the current LTE communication system. However, the report message can be transmitted through a newly defined PUCCH format, not the PUCCH formats implemented in the LTE communication system.

The report message can include information required for predicting a non-Gaussian interference characteristic, and the information required for predicting the non-Gaussian interference characteristic can include information related to received signal strength of a DI signal. Here, the information related to the received signal strength can include various parameters which can indicate the received signal strength such as received signal code power (RSCP), reference signal received power (RSRP), a reference signal received quality (RSRQ), a carrier-to-interference noise ratio (CINR), a signal-to-noise ratio (SNR), a block error rate (BLER), a received signal strength indicator (RSSI), an INR, and/or the like.

After receiving the report message, the eNB detects a non-Gaussian interference characteristic based on the information required for predicting the non-Gaussian interference characteristic included in the report message, e.g., information related to received signal strength of a DI signal.

Meanwhile, the UE can quantize information related to received signal strength of a DI signal and transmit the quantized information for decreasing feed back overhead which occurs according to feedback of the information required for predicting the non-Gaussian interference characteristic, e.g., the information related to the received signal strength of the DI signal. For convenience, it will be assumed that the information related to the received signal strength of the DI signal is an INR level.

For example, the INR level can be expressed with two bits. If a value of the two bits is ‘00’, it means that a received INR level of DI is 0˜x1 dB. If a value of the two bits is ‘01’, it means that a received INR level of DI is x1˜x2 dB. If a value of the two bits is ‘10’, it means that a received INR level of DI is x2˜x3 dB. If a value of the two bits is ‘11’, it means that a received INR level of DI is greater than or equal to x3 dB.

Information required for predicting a non-Gaussian interference characteristic proposed in an embodiment of the present disclosure, e.g., information related to received signal strength of a DI signal can be fed back to an eNB through the report message. For example, the report message can be included in a PUCCH format used in the LTE communication system. For example, the report message can be included in a PUCCH format 2 defined for reporting CSI, and the PUCCH format 2 is implemented with, for example, eleven bits.

In the above description, the report message is fed back through one of PUCCH formats, e.g., a PUCCH format 2 implemented in the current LTE communication system. However, the report message can be transmitted through a newly defined PUCCH format, not the PUCCH formats implemented in the LTE communication system.

Meanwhile, the UE 310 transmits, to the eNB 300, a report message including the CQI index, the information related to the Rx scheme, and the information related to the interference environment characteristic at operation 315. The report message can be implemented with various forms, and a detailed description thereof will be omitted herein.

In FIG. 3, the UE 310 transmits the report message to the eNB 300 according to the request of the eNB 300, i.e., according to the reception of the report request message from the eNB 300. However, the UE 310 can periodically or aperiodically transmit the report message to the eNB 300 without receiving the report request message from the eNB 300. Here, a case that the UE 310 aperiodically transmits a report message is a case that a specific event occurs, the specific event can be implemented with various forms, and a detailed description thereof will be omitted herein.

After receiving the report message from the UE 310, the eNB 300 performs a scheduling operation based on the CQI index, the information related to the Rx scheme, and the information related to the interference environment characteristic included in the report message, and determines an MCS level to be applied to the UE 310, e.g., an optimal MCS level at operation 317. The eNB 300 transmits a message including the determined MCS level to the UE 310 at operation 319. After receiving the message including the MCS level from the eNB 300, the UE 310 performs a decoding operation on a received signal based on the MCS level at operation 321.

Although FIG. 3 illustrates a signal transmitting/receiving process between an eNB and a UE for controlling an operation of the UE in a communication system according to an embodiment of the present disclosure, various changes could be made to FIG. 3. For example, although shown as a series of operations, various operations in FIG. 3 could overlap, occur in parallel, occur in a different order, or occur multiple times.

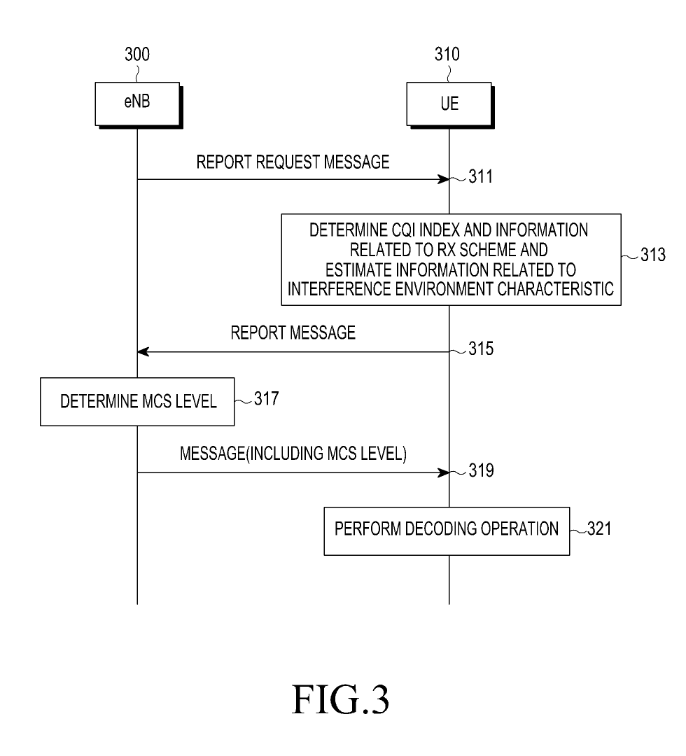

A signal transmitting/receiving process between an eNB and a UE for controlling an operation of the UE in a communication system according to an embodiment of the present disclosure has been described with reference to FIG. 3, and a signal transmitting/receiving process between an eNB and a UE according to a link adaptation scheme in a communication system according to an embodiment of the present disclosure will be described with reference to FIG. 4.

FIG. 4 schematically illustrates a signal transmitting/receiving process between an eNB and a UE according to a link adaptation scheme in a communication system according to an embodiment of the present disclosure.

Referring to FIG. 4, the communication system includes an eNB 400 and a UE 410.

The eNB 400 transmits a report request message to the UE 410 at operation 411. The report request message has been described with reference to FIG. 3, so a detailed description thereof will be omitted herein.

Although not shown in FIG. 4, the UE 410 which receives the report request message from the eNB 400 determines a CQI index, determines information related to an Rx scheme which the UE applies, and estimates information related to an interference environment characteristic which the UE 410 experiences. The operation of determining the CQI index and the information related to the Rx scheme and estimating the information related to the interference environment characteristic has been described with reference to FIG. 3, so a detailed description thereof will be omitted herein.

The UE 410 transmits, to the eNB 400, a report message including the CQI index, the information related to the Rx scheme, and the information related to the interference environment characteristic at operation 413. The report message has been described with reference to FIG. 3, so a detailed description thereof will be omitted herein.

In FIG. 4, the UE 410 transmits the report message to the eNB 400 according to the request of the eNB 400, i.e., according to the reception of the report request message from the eNB 400. However, the UE 410 can periodically or aperiodically transmit the report message to the eNB 400 without receiving the report request message from the eNB 400. This has been described with reference to FIG. 3, so a detailed description thereof will be omitted herein.

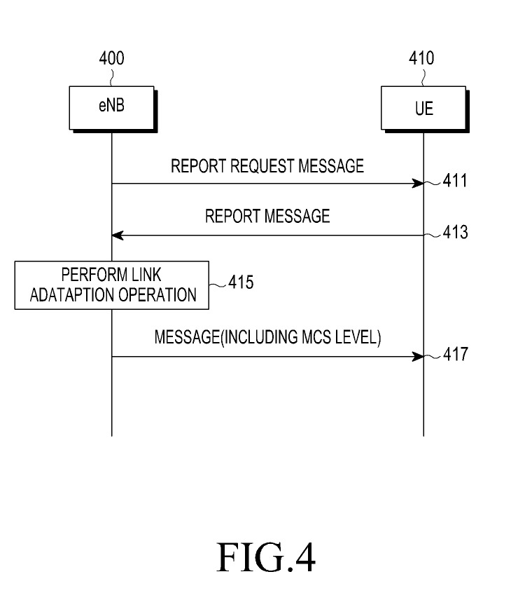

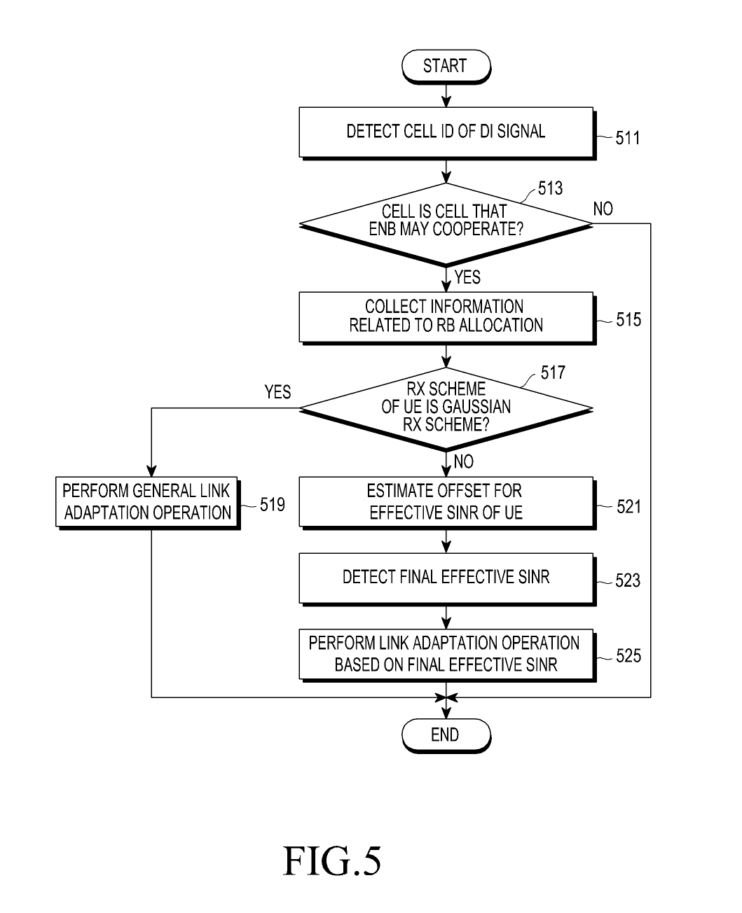

After receiving the report message from the UE 410, the eNB 400 performs a link adaptation operation on the UE 410 based on the CQI index, the information related to the Rx scheme, and the information related to the interference environment characteristic included in the report message at operation 415. The link adaptation operation performed in the eNB 400 will be described with reference to FIGS. 5 and 6, so a detailed description thereof will be omitted herein.

The eNB 400 determines an MCS level to be applied to the UE 410, e.g., an optimal MCS level based on the result of the link adaptation operation. The eNB 400 transmits a message including the determined MCS level to the UE 410 at operation 417.

Although FIG. 4 illustrates a signal transmitting/receiving process between an eNB and a UE according to a link adaptation scheme in a communication system according to an embodiment of the present disclosure, various changes could be made to FIG. 4. For example, although shown as a series of operations, various operations in FIG. 4 could overlap, occur in parallel, occur in a different order, or occur multiple times.

A signal transmitting/receiving process between an eNB and a UE according to a link adaptation scheme in a communication system according to an embodiment of the present disclosure has been described with reference to FIG. 4, and a process of performing a link adaptation scheme in an eNB in a communication system according to an embodiment of the present disclosure will be described with reference to FIG. 5.

FIG. 5 schematically illustrates a process of performing a link adaptation scheme in an eNB in a communication system according to an embodiment of the present disclosure.

Referring to FIG. 5, an eNB detects a cell ID of a DI signal included in information fed back by a UE at operation 511. The eNB determines whether a cell is a cell with which the eNB can cooperate based on the cell ID of the DI signal at operation 513. For example, the operation of determining whether the cell is the cell with which the eNB can cooperate can include an operation of determining whether the cell is a cell, i.e., an eNB which is connected to the eNB through a low latency backhaul or an operation of determining whether the cell is one of sectors which the eNB manages.

If the cell is the cell with which the eNB can cooperate, the eNB collects information related to RB allocation of the cell with which the eNB can cooperate at the next scheduling time, i.e., a DI cell with which the eNB can cooperate at operation 515. The information related to the RB allocation of the DI cell includes RB allocation information and an RB hitting rate which affects a target signal of the DI cell. The RB allocation information of the DI cell is interference signal information collected through a backhaul, and the RB hitting rate can be detected based on the RB allocation information.

The eNB determines whether an Rx scheme of the UE is a Gaussian Rx scheme based on the information received from the UE at operation 517. If the Rx scheme is the Gaussian Rx scheme, the eNB performs a link adaptation operation corresponding to a general link adaptation scheme at operation 519. For example, the general link adaptation scheme is a link adaptation scheme which is based on a CQI index, and a detailed description for the general link adaptation scheme will be omitted herein.

If the Rx scheme of the UE is not the Gaussian Rx scheme, that is, if the Rx scheme of the UE is a non-Gaussian Rx scheme, or an Rx scheme which supports all of a Gaussian Rx scheme and a non-Gaussian Rx scheme, the eNB detects received signal strength of the DI signal, e.g., Rx power level of the DI signal and an RB hitting rate H of the DI cell, and estimates an offset y for an effective SINR of the UE based on the Rx power level P of the DI signal and the RB hitting rate H of the DI signal at operation 521.

The eNB detects a final effective SINR based on an effective SINR estimation value which is estimated based on a CQI index and an effective SINR estimation value which is estimated based on the Rx power level P of the DI signal and the RB hitting rate H of the DI signal at operation 523. If the effective SINR estimation value which is estimated based on the CQI index is x, and the effective SINR offset which is estimated based on the Rx power level P of the DI signal and the RB hitting rate H of the DI signal is y, the final effective SINR is determined as x+y.

The eNB performs a link adaptation operation based on the final effective SINR at operation 525.

Although FIG. 5 illustrates a process of performing a link adaptation scheme in an eNB in a communication system according to an embodiment of the present disclosure, various changes could be made to FIG. 5. For example, although shown as a series of operations, various operations in FIG. 5 could overlap, occur in parallel, occur in a different order, or occur multiple times.

A process of performing a link adaptation scheme in an eNB in a communication system according to an embodiment of the present disclosure has been described with reference to FIG. 5, and a process of estimating an effective SINR based on a received power level and an RB hitting rate of a DI signal in an eNB in a communication system according to an embodiment of the present disclosure will be described with reference to FIG. 6.

FIG. 6 schematically illustrates a process of estimating an effective SINR based on a received power level and an RB hitting rate of a DI signal in an eNB in a communication system according to an embodiment of the present disclosure.

Referring to FIG. 6, Hk which is a criterion for determining an RB hitting rate and an effective SINR offset level Dk can be determined as various values according to a target system or a target network, and a detailed description thereof will be omitted herein.

As shown in FIG. 6, in an embodiment of the present disclosure, an eNB manages an effective SINR offset mapping table, and it will be understood that the effective SINR offset mapping table is based on relation among an Rx power level P of a DI signal, an RB hitting rate H of the DI signal, and effective SINR offset x.

A process of estimating an effective SINR based on a received power level and an RB hitting rate of a DI signal in an eNB in a communication system according to an embodiment of the present disclosure has been described with reference to FIG. 6, and various embodiments related to a link adaptation scheme proposed in an embodiment of the present disclosure will be described below.

Firstly, a link adaptation operation according to an embodiment of the present disclosure in a case that change in an interference channel is relatively large per sub-frame, and a network structure is similar to a structure of a centralized radio access network (C-RAN) will be described below.

The relatively large change per sub-frame in the interference channel means that an interference channel environment in the current scheduling time is significantly different from an interference channel environment in the next scheduling time for a UE. So, a DI eNB does not change, but RB allocation situation for the UE can change, and an RB hitting ratio can change.

In a case that a downlink environment is considered, an assumption that a dominant eNB does not change until the next scheduling time of a UE can be reasonable.

So, if information included in a report message transmitted by the UE in a previous scheduling time is used, severe performance degradation can occur due to mismatch between an interference environment in the previous scheduling time and an interference environment in a current scheduling time.

Further, as well as the relatively large change per sub-frame in the interference channel, a network where a low latency backhaul exists among all macro eNBs, e.g., a C-RAN can be considered. Here, the low latency backhaul is almost identical to an ideal backhaul.

So, in a case that change in an interference channel is relatively large per sub-frame, and a network structure is similar to a structure of a C-RAN, a UE and an eNB need to additionally perform the following operations when a link adaptation operation according to an embodiment of the present disclosure is performed compared to an operation performed when a general link adaptation operation is performed.

(1) UE Side

A UE reports, to an eNB, information related to whether the UE is able to apply a non-Gaussian Rx scheme. The UE estimates a cell ID and an INR of a DI signal based on a signal received in the current time. The UE can use a general interference environment estimation scheme when estimating an interference environment, and a detailed description thereof will be omitted herein. The cell ID and the INR of the DI signal can be estimated based on a synchronization signal, e.g., a primary synchronization signal (PSS) or a secondary synchronization signal (SSS), or a common reference signal (CRS).

(2) eNB Side

If an eNB determines that a UE is unable to apply a non-Gaussian Rx scheme based on information related to whether the UE is able to apply the non-Gaussian Rx scheme, the eNB performs an operation according to a general link adaptation scheme. That is, the eNB performs a general MCS level determining operation.

If the eNB determines that the UE is able to apply the non-Gaussian Rx scheme, the eNB performs an operation according to a link adaptation scheme which is based on an interference environment characteristic. That is, the eNB performs an MCS level determining operation by reflecting an interference environment characteristic.

The eNB acquires RB allocation information of a cell which corresponds to the cell ID of the DI signal reported by the UE through a backhaul in the next scheduling time, and estimates an RB hitting ratio of an interference signal to a target signal based on the RB allocation information of the cell which corresponds to the cell ID of the DI signal. The eNB performs an MCS level determining operation based on the estimated RB hitting ratio. The eNB determines the number of DI signals based on the INR reported by the UE and determines an MCS level based on this.

Secondly, a link adaptation operation according to an embodiment of the present disclosure in a case that change in an interference channel is relatively large per sub-frame, and a network structure is similar to a structure of a partial C-RAN will be described below.

The relatively large change per sub-frame in the interference channel means that an interference channel environment in the current scheduling time for a UE is significantly different from an interference channel environment in the next scheduling time for the UE. So, a DI eNB does not change, but RB allocation situation for the UE can change, and an RB hitting ratio can change.

So, in a case that a downlink environment is considered, an assumption that a dominant eNB does not change until the next scheduling time for a UE can be reasonable.

So, if information included in a report message transmitted by the UE in the previous scheduling time is used, severe performance degradation can occur due to mismatch between an interference environment in the previous scheduling time and an interference environment in the current scheduling time.

Further, as well as the relatively large change per sub-frame in the interference channel, a network where a low latency backhaul exists among some macro eNBs, e.g., a partial C-RAN can be considered. Here, the low latency backhaul is almost identical to an ideal backhaul, and a low latency backhaul does not exist among all macro eNBs in the partial C-RAN. Here, a structure of the partial C-RAN can be similar to a structure of a communication system where there is a non-ideal backhaul among macro eNBs, and there is a low latency backhaul among sectors included in a macro cell or small cells, and which supports a network assisted interference cancellation and suppression (NAICS) scheme.

So, in a case that change in an interference channel is relatively large per sub-frame, and a network structure is similar to a structure of a partial C-RAN, a UE and an eNB need to additionally perform the following operations when a link adaptation operation according to an embodiment of the present disclosure is performed compared to an operation performed when a general link adaptation operation is performed.

(1) UE Side

An operation of a UE is identical to an operation of a UE according to a link adaptation operation according to an embodiment of the present disclosure in a case that change in an interference channel is relatively large per sub-frame, and a network structure is similar to a structure of a C-RAN, so a detailed description thereof will be omitted herein.

(2) eNB Side

If an eNB determines that a UE is unable to apply a non-Gaussian Rx scheme based on information related to whether the UE is able to apply the non-Gaussian Rx scheme, the eNB performs an operation according to a general link adaptation scheme. That is, the eNB performs a general MCS level determining operation.

Alternatively, if the UE is able to apply the non-Gaussian Rx scheme, the eNB determines whether a cell ID of a DI signal reported by the UE is identical to a cell ID of a macro cell or a sector or a small cell which is connected to the eNB through a low latency backhaul. If the cell ID of the DI signal reported by the UE is not identical to the cell ID of the macro cell or the sector or the small cell which is connected to the eNB through the low latency backhaul, that is, if the cell of the DI signal is not the cell which is connected to the eNB through the low latency backhaul, the eNB performs an operation according to a general link adaptation scheme. That is, the eNB performs a general MCS level determining operation.

If the cell ID of the DI signal reported by the UE is identical to the cell ID of the macro cell or the sector or the small cell which is connected to the eNB through the low latency backhaul, that is, if the cell of the DI signal is the cell which is connected to the eNB through the low latency backhaul, the eNB predicts an RB hitting ratio of an interference signal based on RB allocation information of a DI signal in the next scheduling time for the UE, and determines an MCS level based on the predicted RB hitting ratio.

The eNB can detect the number of DI signals based on the INR reported by the UE and determine an MCS level based on the number of the DI signals.

Thirdly, an example of a link adaptation operation according to an embodiment of the present disclosure in a case that change in an interference channel is not relatively large per sub-frame, and there is no low latency backhaul among macro eNBs will be described below.

A case that the change in the interference channel is not relatively large per sub-frame means that an interference channel environment in the current time hardly changes until the next scheduling time for a UE.

As described above, in a case that change in an interference channel is not relatively large per sub-frame, and there is no low latency backhaul among macro eNBs, a UE and an eNB need to additionally perform the following operations when a link adaptation operation according to an embodiment of the present disclosure is performed compared to an operation performed when a general link adaptation operation is performed.

(1) UE Side

A UE reports, to an eNB, information related to whether the UE is able to apply a non-Gaussian Rx scheme. The UE estimates at least one of an RB hitting ratio of a DI signal, an INR, and a modulation scheme based on a signal received in the current time. The UE can use a general interference environment estimating scheme when estimating an interference environment, and a detailed description thereof will be omitted herein. The RB hitting ratio of the DI signal can be determined based on the first scheme of determining whether there is an interference signal or the second scheme of determining whether there is an interference signal. Here, each of the first scheme and the second scheme denotes a scheme of determining whether there is an interference signal, the first scheme is an energy detection-based scheme, and the second scheme is log likelihood ratio (LLR)-based scheme. The UE can estimate an INR based on a CRS, or can detect a modulation scheme for a DI signal based on an LLR-based modulation order estimating scheme.

(2) eNB Side

Upon determining that a UE is unable to apply a non-Gaussian Rx scheme based on information related to whether the UE is able to apply the non-Gaussian Rx scheme reported by the UE, an eNB performs an operation according to a general link adaptation scheme. That is, the eNB performs a general MCS level determining operation.

If the UE is able to apply the non-Gaussian Rx scheme, the eNB performs an operation according to a link adaptation scheme which is an interference environment characteristic. That is, the eNB performs an MCS level determining operation by reflecting the interference environment characteristic. Here, the eNB performs the MCS level determining operation by reflecting a characteristic that a required SINR becomes small if the number of DI signals is small, an RB hitting ratio according to a DI signal is small, or a modulation order of the DI signal is low.

Fourthly, another example of a link adaptation operation according to an embodiment of the present disclosure in a case that change in an interference channel is not relatively large per sub-frame, and there is no low latency backhaul among macro eNBs will be described below.

A case that the change in the interference channel is not relatively large per sub-frame means that an interference channel environment in the current time hardly changes until the next scheduling time for a UE.

As described above, in a case that change in an interference channel is not relatively large per sub-frame, and there is no low latency backhaul among macro eNBs, a UE and an eNB need to additionally perform the following operations when a link adaptation operation according to an embodiment of the present disclosure is performed compared to an operation performed when a general link adaptation operation is performed.

(1) UE Side

As described in a link adaptation operation according to an embodiment of the present disclosure in a case that change in an interference channel is not relatively large per sub-frame, and there is no low latency backhaul among macro eNBs, a UE estimates at least one of an RB hitting ratio and an INR of a DI signal based on a signal received in the current time.

As described in FIG. 6, the UE estimates an effective SINR offset y based on the at least one of the RB hitting ratio and the INR of the DI signal estimated by the UE, and determines x+y as an effective SINR by reflecting the estimated effective SINR offset y. The UE determines a CQI based on the determined effective SINR, and reports the determined CQI to an eNB.

(2) eNB Side

An eNB estimates an effective SINR based on a CQI, and determines an optimal MCS level for a UE based on the estimated effective SINR. The eNB informs the UE of the determined optimal MCS level.

As described above, in a case that change in an interference channel is not relatively large per sub-frame, and there is no low latency backhaul among macro eNBs, it will be understood that a link adaptation operation according to an embodiment of the present disclosure can be performed by modifying an operation of a UE without modifying an operation of an eNB.

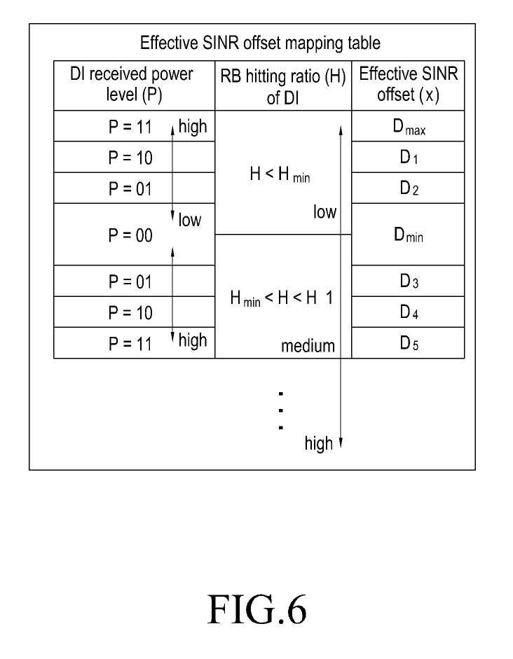

An ISC operation according to an ISC scheme in a communication system according to an embodiment of the present disclosure will be described with reference to FIG. 7.

FIG. 7 schematically illustrates an ISC operation according to an ISC scheme in a communication system according to an embodiment of the present disclosure.

Referring to FIG. 7, in a case that an ISC scheme proposed in an embodiment of the present disclosure is used, an SINR of a UE which applies a Gaussian Rx scheme can be similar to an SINR of a UE which applies a non-Gaussian Rx scheme.

So, an eNB performs an ISC operation thereby the number of interference signals of which INRs are relatively large is as small as possible in a UE which applies a non-Gaussian Rx scheme. Further, the eNB performs an ISC operation thereby an RB hitting ratio is as small as possible in a UE which applies a non-Gaussian Rx scheme even though relatively large interference signal affects the UE.

As described above, in a case that an ISC operation is performed, UEs which apply a Gaussian Rx scheme can maintain performance which is almost similar to performance according to a general scheme of controlling an operation of a UE, and performance enhancement for UEs which apply a non-Gaussian Rx scheme can be maximized.

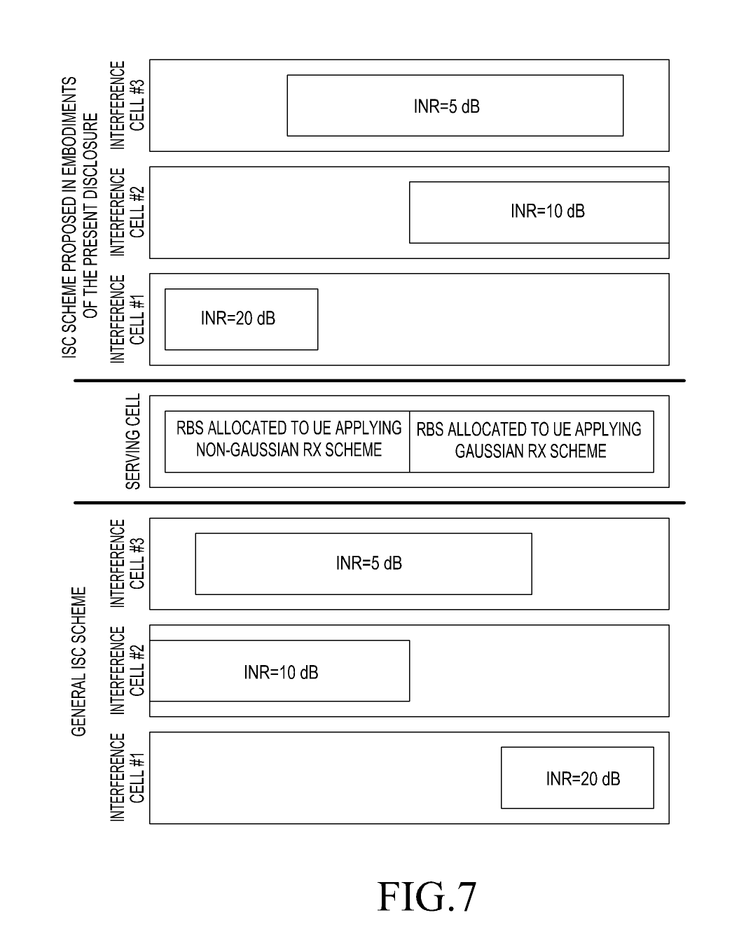

An ISC operation according to an ISC scheme in a communication system according to an embodiment of the present disclosure has been described with reference to FIG. 7, and a signal transmitting/receiving process between an eNB and a UE according to an ISC scheme in a communication system according to an embodiment of the present disclosure will be described with reference to FIG. 8.

FIG. 8 schematically illustrates a signal transmitting/receiving process between an eNB and a UE according to an ISC scheme in a communication system according to an embodiment of the present disclosure.

Referring to FIG. 8, the communication system includes an eNB 800 and a UE 810.

The eNB 800 transmits a report request message to the UE 810 at operation 811. The report request message has been described with reference to FIG. 3, so a detailed description thereof will be omitted herein.

Although not shown in FIG. 8, the UE 810 which receives the report request message from the eNB 800 determines a CQI index, determines information related to an Rx scheme which the UE applies, and estimates information related to an interference environment characteristic which the UE 810 experiences. The operation of determining the CQI index and the information related to the Rx scheme and estimating the information related to the interference environment characteristic has been described with reference to FIG. 3, so a detailed description thereof will be omitted herein.

The UE 810 transmits, to the eNB 800, a report message including the CQI index, the information related to the Rx scheme, and the information related to the interference environment characteristic at operation 813. The report message has been described with reference to FIG. 3, so a detailed description thereof will be omitted herein.

In FIG. 8, the UE 810 transmits the report message to the eNB 800 according to the request of the eNB 800, i.e., according to the reception of the report request message from the eNB 800. However, the UE 810 can periodically or aperiodically transmit the report message to the eNB 800 without receiving the report request message from the eNB 800. This has been described with reference to FIG. 3, so a detailed description thereof will be omitted herein.

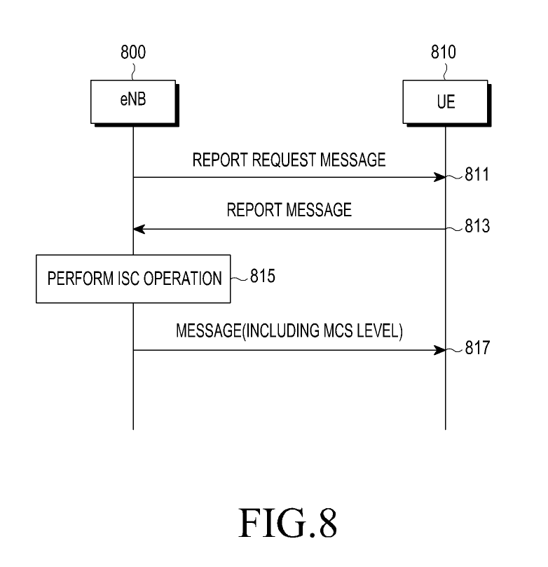

After receiving the report message from the UE 810, the eNB 800 performs an ISC operation for the UE 810 based on the CQI index, the information related to the Rx scheme, and the information related to the interference environment characteristic included in the report message at operation 815. The ISC operation performed in the eNB 800 will be described with reference to FIG. 9, so a detailed description thereof will be omitted herein.

The eNB 800 determines an MCS level to be applied to the UE 810, e.g., an optimal MCS level based on the result of the link adaptation operation. The eNB 800 transmits a message including the determined MCS level to the UE 810 at operation 817.

Although FIG. 8 illustrates a signal transmitting/receiving process between an eNB and a UE according to an ISC scheme in a communication system according to an embodiment of the present disclosure, various changes could be made to FIG. 8. For example, although shown as a series of operations, various operations in FIG. 8 could overlap, occur in parallel, occur in a different order, or occur multiple times.

A signal transmitting/receiving process between an eNB and a UE according to an ISC scheme in a communication system according to an embodiment of the present disclosure has been described with reference to FIG. 8, and a process of performing an ISC operation in an eNB in a communication system according to an embodiment of the present disclosure will be described with reference to FIG. 9.

FIG. 9 schematically illustrates a process of performing an ISC operation in an eNB in a communication system according to an embodiment of the present disclosure.

Referring to FIG. 9, an eNB detects a cell ID of a DI signal in information fed back by a UE at operation 911. The eNB determines whether a cell is a cell which performs an ISC operation based on the cell ID of the DI signal at operation 913.

If the cell is the cell which performs the ISC operation, the eNB selects cells with which the eNB will perform an inter-cell interference coordination (ICIC) operation at operation 915. Here, the selected cells which perform the ISC operation with the eNB can share RNTP, OI, and information related to an Rx scheme which can be applied to a scheduled UE through a backhaul. For example, the RNTP can be implemented with one bit. If a value of the one bit is the first value, e.g., ‘0’, it means that an RB is used. If a value of the one bit is the second value, e.g., ‘1’, it means that an RB is not used. The OI denotes an interference strength level per RB. For example, the interference strength level can be classified into three levels, e.g., a low level, a medium level, and a high level. There can be various scheme of classifying the interference strength level into the low level, the medium level, and the high level. For example, the interference strength level can be classified into the low level, the medium level, and the high level based on preset threshold values.

Meanwhile, the eNB predicts an Rx scheme which a target UE, i.e., a UE with which the eNB performs an ISC operation is able to apply based on the information received from the UE at operation 917. The eNB determines whether the predicted Rx scheme of the target UE is a Gaussian Rx scheme. If the predicted Rx scheme of the target UE is the Gaussian Rx scheme, the eNB proceeds to operation 919.

The eNB predicts an Rx scheme which an interference cell UE which is scheduled based on the information shared through the backhaul is able to apply at operation 919. The eNB determines whether the predicted Rx scheme of the interference cell UE is a Gaussian Rx scheme. If the predicted Rx scheme of the interference cell UE is the Gaussian Rx scheme, the eNB proceeds to operation 921.

The eNB performs a general ICIC operation since the predicted Rx scheme of the interference cell UE is the Gaussian Rx scheme at operation 921. That is, the eNB performs an ISC operation based on RNTP and OI thereby SINRs of a serving cell and an interference cell are maximized. This will be described below.

The eNB allocates an RB for which RNTP is zero (RNTP=0) in an interference cell to the target UE. If there is no RB for which the RNTP is zero in the interference cell, the eNB allocates an RB from an RB of which OI is small in a neighbor cell to the target UE.

If the predicted Rx scheme of the interference cell UE is not the Gaussian Rx scheme, that is, if the predicted Rx scheme of the interference cell UE is a non-Gaussian Rx scheme, or an Rx scheme which supports all of a Gaussian Rx scheme and a non-Gaussian Rx scheme, the eNB performs an ICIC operation based on the Rx scheme of the interference cell UE at operation 923. That is, the eNB performs the ICIC operation based on the Rx scheme of the interference cell UE thereby an SINR is maximized and a characteristic according to a non-Gaussian Rx scheme of the interference cell UE. This will be described below.

The eNB allocates an RB for which RNTP is zero (RNTP=0) in an interference cell to the target UE. If there is no RB for which the RNTP is zero in the interference cell, the eNB allocates an RB from an RB of which OI is small in a neighbor cell to the target UE. Further, the eNB can allocate a part of RBs allocated to the interference UE which applies the non-Gaussian Rx scheme to the target UE. So, if the ICIC operation is performed as described above, SINRs of a serving cell and an interference cell are maximized, and an interference channel environment where an RB hitting ratio is relatively small can be formed for a UE which applies a non-Gaussian Rx scheme.

If the predicted Rx scheme of the target UE is not the Gaussian Rx scheme, that is, if the predicted Rx scheme of the target UE is a non-Gaussian Rx scheme, or an Rx scheme which supports all of a Gaussian Rx scheme and a non-Gaussian Rx scheme, the eNB predicts an Rx scheme which a scheduled interference cell UE can apply based on the information shared through the backhaul at operation 925. The eNB determines whether the predicted Rx scheme of the interference cell UE is a Gaussian Rx scheme. If the predicted Rx scheme of the interference cell UE is the Gaussian Rx scheme, the eNB proceeds to operation 927.

If the predicted Rx scheme of the interference cell UE is the Gaussian Rx scheme, the eNB performs an ICIC operation based on the Rx scheme of the target UE at operation 927. That is, the eNB performs the ICIC operation based on the Rx scheme of the target UE thereby an SINR can be maximized and a characteristic according to a non-Gaussian Rx scheme of the target UE can be reflected. This will be described below.

The eNB allocates an RB for which RNTP is zero (RNTP=0) in an interference cell to the target UE. If there is no RB for which the RNTP is zero in the interference cell, the eNB allocates an RB from an RB of which OI is small in a neighbor cell to the target UE. Further, the eNB allocates an RB to the target UE thereby relatively strong interference signals are partially overlapped. So, if the ICIC operation is performed as described above, SINRs of a serving cell and an interference cell are maximized, and an interference channel environment where an RB hitting ratio is relatively small can be formed for a UE which applies a non-Gaussian Rx scheme.

If the predicted Rx scheme of the interference cell UE is not the Gaussian Rx scheme at operation 925, that is, if the predicted Rx scheme of the interference cell UE is a non-Gaussian Rx scheme, or an Rx scheme which supports all of a Gaussian Rx scheme and a non-Gaussian Rx scheme, the eNB performs an ICIC operation based on the Rx scheme of the target UE and the Rx scheme of the interference cell UE at operation 929. That is, the eNB performs the ICIC operation based on the Rx scheme of the target UE and the Rx scheme of the interference cell UE thereby an SINR can be maximized and a characteristic according to a non-Gaussian Rx scheme of the target UE and a characteristic according to a non-Gaussian Rx scheme of the interference cell UE can be reflected. This will be described below.

The eNB allocates an RB for which RNTP is zero (RNTP=0) in an interference cell to the target UE. If there is no RB for which the RNTP is zero in the interference cell, the eNB allocates an RB from an RB of which OI is small in a neighbor cell to the target UE. Further, the eNB allocates a part of RBs allocated to an interference cell UE which applies a non-Gaussian Rx scheme to a target UE and allocates an RB to the target UE thereby relatively strong interference signals are partially overlapped. So, if the ICIC operation is performed as described above, SINRs of a serving cell and an interference cell are maximized, and an interference channel environment where an RB hitting ratio is relatively small can be formed for a UE which applies a non-Gaussian Rx scheme.

Although FIG. 9 illustrates a process of performing an ISC operation in an eNB in a communication system according to an embodiment of the present disclosure, various changes could be made to FIG. 9. For example, although shown as a series of operations, various operations in FIG. 9 could overlap, occur in parallel, occur in a different order, or occur multiple times.

A process of performing an ISC operation in an eNB in a communication system according to an embodiment of the present disclosure has been described with reference to FIG. 9, and various embodiments related to an ISC scheme proposed in an embodiment of the present disclosure will be described below.

Firstly, an ISC operation in a communication system according to an embodiment of the present disclosure in a case that change in an interference channel is relatively large per sub-frame, and a network structure is similar to a structure of a C-RAN will be described below.

The relatively large change per sub-frame in the interference channel means that an interference channel environment in the current scheduling time is significantly different from an interference channel environment in the next scheduling time for a UE. So, a DI eNB does not change, but RB allocation situation for the UE can change, and an RB hitting ratio can change.

In a case that a downlink environment is considered, an assumption that a dominant eNB does not change until the next scheduling time of a UE can be reasonable.

So, if information included in a report message transmitted by the UE in the previous scheduling time is used, severe performance degradation due to mismatch between an interference environment in the previous scheduling time and an interference environment in the current scheduling time can occur.

Further, as well as the relatively large change per sub-frame in the interference channel, a network where a low latency backhaul exists among all macro eNBs, e.g., a C-RAN can be considered. Here, the low latency backhaul is almost identical to an ideal backhaul.

So, in a case that change in an interference channel is relatively large per sub-frame, and a network structure is similar to a structure of a C-RAN, a UE and an eNB need to additionally perform the following operations when an ISC operation according to an embodiment of the present disclosure is performed compared to an operation performed when a general ISC operation is performed.

(1) UE Side

A UE reports, to an eNB, information related to whether the UE is able to apply a non-Gaussian Rx scheme. The UE estimates a cell ID of a DI signal and an INR based on a signal received in the current time. The UE can use a general interference environment estimation scheme when estimating an interference environment, and a detailed description thereof will be omitted herein. The cell ID of the DI signal and the INR can be estimated based on a synchronization signal, e.g., a PSS or an SSS, or a CRS.

(2) eNB Side

An eNB determines whether a UE can apply a non-Gaussian Rx scheme based on information reported by the UE. The eNB performs an ISC operation with eNBs with which the eNB can cooperate. Here, a process of performing the ISC operation with the eNBs with which the eNB can cooperate in the eNB will be described below.

The eNB detects a DI eNB based on the INR and the cell ID of the DI signal reported by the UE. The eNB detects RB allocation information of the DI eNB through a backhaul. The eNB performs an ISC operation thereby SINRs of UEs to which the eNB provides a service can be similar. So, the eNB performs the ISC operation thereby an RB hitting ratio becomes small even though relatively large interference occurs to a UE which the non-Gaussian Rx scheme.

Meanwhile, if the UE is unable to apply the non-Gaussian Rx scheme, the eNB determines an MCS level for the UE based on a general MCS level determining scheme.

If the UE is able to apply the non-Gaussian Rx scheme, the eNB determines an MCS level for the UE by considering a characteristic for an interference environment for which the ISC operation is performed. Here, the eNB determines an MCS level, e.g., an optimal MCS level by considering the number of DI signals for a target signal, an RB hitting ratio, a modulation scheme, and/or the like.

Secondly, an ISC operation according to an embodiment of the present disclosure in a case that change in an interference channel is relatively large per sub-frame, and a network structure is similar to a structure of a partial C-RAN will be described below.

The relatively large change per sub-frame in the interference channel means that an interference channel environment in the current scheduling time is significantly different from an interference channel environment in the next scheduling time for a UE. So, a DI eNB does not change, but RB allocation situation for the UE can change, and an RB hitting ratio can change.

In a case that a downlink environment is considered, an assumption that a dominant eNB does not change until the next scheduling time of a UE can be reasonable.

So, if information included in a report message transmitted by the UE in the previous scheduling time is used, severe performance degradation due to mismatch between an interference environment in the previous scheduling time and an interference environment in the current scheduling time can occur.

Further, as well as the relatively large change per sub-frame in the interference channel, a network where a low latency backhaul exists among some macro eNBs, e.g., a partial C-RAN can be considered. Here, the low latency backhaul is almost identical to an ideal backhaul, and a low latency backhaul does not exist among all macro eNBs in the partial C-RAN. Here, a structure of the partial C-RAN can be similar to a structure of a communication system where there is a non-ideal backhaul among macro eNBs, and there is a low latency backhaul among sectors included in a macro cell or small cells and which supports an NAICS scheme.

So, in a case that change in an interference channel is relatively large per sub-frame, and a network structure is similar to a structure of a partial C-RAN, a UE and an eNB need to additionally perform the following operations when an ISC operation according to an embodiment of the present disclosure is performed compared to an operation performed when a general ISC operation is performed.

(1) UE Side

An operation of a UE is identical to an operation of a UE according to an ISC operation according to an embodiment of the present disclosure in a case that change in an interference channel is relatively large per sub-frame, and a network structure is similar to a structure of a C-RAN, so a detailed description thereof will be omitted herein.

(2) eNB Side

An eNB determines whether a UE can apply a non-Gaussian Rx scheme based on information reported by the UE. The eNB performs an ISC operation with eNBs with which the eNB can cooperate. Here, a process of performing the ISC operation with the eNBs with which the eNB can cooperate in the eNB will be described below.

The eNB detects a DI eNB with which the eNB can cooperate based on the INR and the cell ID of the DI signal reported by the UE. The eNB detects RB allocation information of the DI eNB with which the eNB can cooperate through a backhaul. The eNB performs an ISC operation thereby SINRs of UEs to which the eNB provides a service can be similar. So, the eNB performs the ISC operation thereby an RB hitting ratio becomes small even though relatively large interference occurs to a UE which the non-Gaussian Rx scheme.

Meanwhile, if the UE is unable to apply the non-Gaussian Rx scheme, the eNB determines an MCS level for the UE based on a general MCS level determining scheme.

If the UE is able to apply the non-Gaussian Rx scheme, the eNB determines an MCS level for the UE by considering a characteristic for an interference environment for which the ISC operation is performed. Here, the eNB determines an MCS level, e.g., an optimal MCS level by considering the number of DI signals for a target signal, an RB hitting ratio, a modulation scheme, and/or the like.

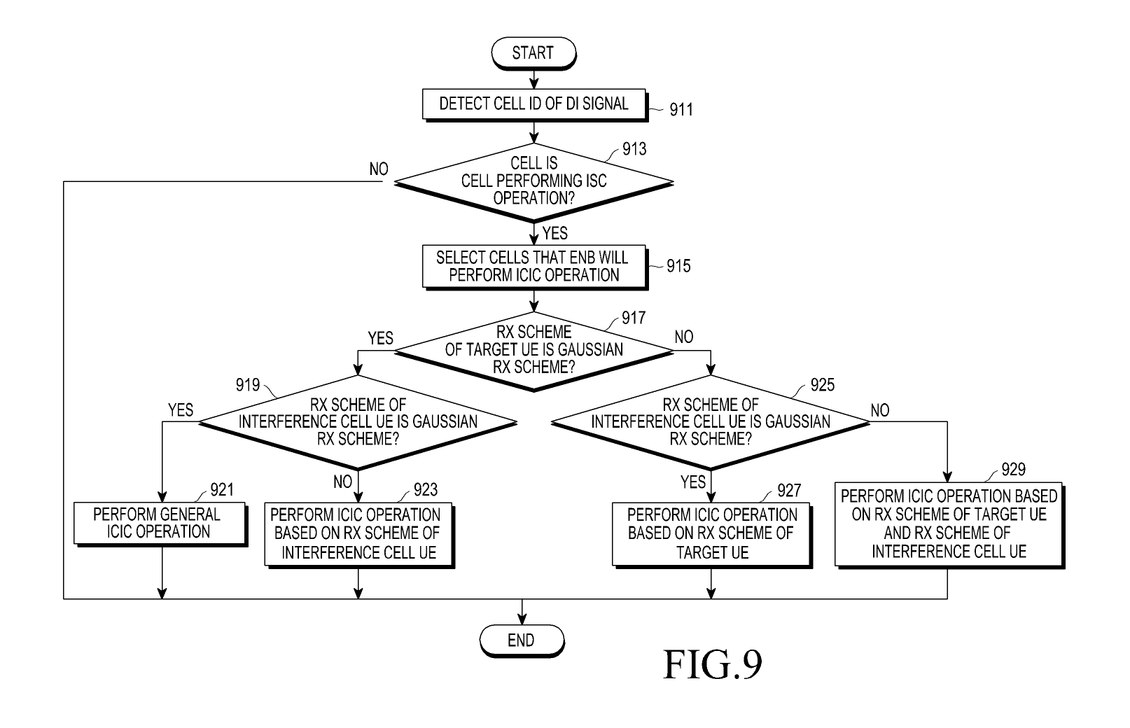

A signal transmitting/receiving process between an eNB and a UE according to an SPIORxS in a communication system according to an embodiment of the present disclosure will be described with reference to FIG. 10.

FIG. 10 schematically illustrates a signal transmitting/receiving process between an eNB and a UE according to an SPIORxS in a communication system according to an embodiment of the present disclosure.

Referring to FIG. 10, the communication system includes an eNB 1000 and a UE 1010.

The eNB 1000 transmits a report request message to the UE 1010 at operation 1011. The report request message has been described with reference to FIG. 3, so a detailed description thereof will be omitted herein.

Although not shown in FIG. 10, the UE 1010 which receives the report request message from the eNB 1000 determines a CQI index, determines information related to an Rx scheme which the UE applies, and estimates information related to an interference environment characteristic which the UE 1010 experiences. The operation of determining the CQI index and the information related to the Rx scheme and estimating the information related to the interference environment characteristic has been described with reference to FIG. 3, so a detailed description thereof will be omitted herein.

The UE 1010 transmits, to the eNB 1000, a report message including the CQI index, the information related to the Rx scheme, and the information related to the interference environment characteristic at operation 1013. The report message has been described with reference to FIG. 3, so a detailed description thereof will be omitted herein.

In FIG. 10, the UE 1010 transmits the report message to the eNB 1000 according to the request of the eNB 1000, i.e., according to the reception of the report request message from the eNB 1000. However, the UE 1010 can periodically or aperiodically transmit the report message to the eNB 1000 without receiving the report request message from the eNB 1000. This has been described with reference to FIG. 3, so a detailed description thereof will be omitted herein.

After receiving the report message from the UE 1010, the eNB 1000 performs an operation of predicting and indicating optimal receiving scheme for the UE 1010 based on the CQI index, the information related to the Rx scheme, and the information related to the interference environment characteristic included in the report message at operation 1015. A process of performing the operation of predicting and indicating the optimal receiving scheme in the eNB 1000 will be described below.

Firstly, the eNB 1000 detects DI cells with which the eNB 1000 can cooperate using cell IDs of DI signals. The eNB 1000 detects RB allocation information of the detected DI cells with which the eNB 1000 can cooperate through a backhaul. The eNB 1000 performs an ISC operation based on the RB allocation information of the detected DI cells with which the eNB 1000 can cooperate.

The eNB 1000 determines whether there is a need for the UE 1010 to apply a non-Gaussian Rx scheme based on an interference environment according to the ISC operation. For example, the eNB 1000 determines whether there is the need for the UE 1010 to apply the non-Gaussian Rx scheme by performing a threshold test for an RB hitting ratio of a DI signal.

That is, in a case that the RB hitting ratio of the DI signal is H, and a threshold RB hitting ratio is Hth, if the RB hitting ratio H of the DI signal is greater than the threshold RB hitting ratio Hth (H>Hth), the eNB 1000 determines that the UE 1010 needs to apply a Gaussian Rx scheme. If the RB hitting ratio H of the DI signal is equal to or less than the threshold RB hitting ratio Hth (H≦Hth), the eNB 1000 determines that the UE 1010 needs to apply a non-Gaussian Rx scheme.

Upon determining that the UE 1010 needs to apply the non-Gaussian Rx scheme, the eNB 1000 informs to the UE 1010 that the UE 1010 needs to apply the non-Gaussian Rx scheme and requests the UE 1010 to report interference channel information required for applying the non-Gaussian Rx scheme. For example, the interference channel information can include cell IDs of a plurality of DI signals and information related to received power of the plurality of DI signals.

Upon determining that the UE 1010 does not need to apply the non-Gaussian Rx scheme, the eNB 1000 informs to the UE 1010 that the UE 1010 does not need to apply the non-Gaussian Rx scheme and requests the UE 1010 to report minimum interference channel information required for applying a Gaussian Rx scheme and monitoring an interference channel characteristic. For example, the minimum interference channel information can include a cell ID of the first DI signal and information related to the received power of the first DI signal.

Meanwhile, the eNB 1000 transmits, to the UE 1010, a message including an MCS level to be applied to the UE 1010, information related to an Rx scheme which the UE 1010 will apply, and information related to an interference channel which the UE 1010 will report based on the result of the operation of predicting and indicating the optimal receiving scheme at operation 1017.

The UE 1010 performs a decoding operation on a received signal based on the information included in the message, and estimates interference channel information. The UE 1010 transmits, to the eNB 1000, a report message including a CQI index, information related to an Rx scheme, and information related to an interference environment characteristic at operation 1019. The report message has been described with reference to FIG. 3, so a detailed description thereof will be omitted herein.

Although FIG. 10 illustrates a signal transmitting/receiving process between an eNB and a UE according to an SPIORxS in a communication system according to an embodiment of the present disclosure, various changes could be made to FIG. 10. For example, although shown as a series of operations, various operations in FIG. 10 could overlap, occur in parallel, occur in a different order, or occur multiple times.

A signal transmitting/receiving process between an eNB and a UE according to an SPIORxS in a communication system according to an embodiment of the present disclosure has been described with reference to FIG. 10, and various embodiments related to an SPIORxS proposed in an embodiment of the present disclosure will be described below.

An operation of predicting and indicating an optimal receiving scheme in a communication system according to an embodiment of the present disclosure in a case that change in an interference channel is relatively large per sub-frame, and a network structure is similar to a structure of a partial C-RAN will be described below.

The relatively large change per sub-frame in the interference channel means that an interference channel environment in the current scheduling time is significantly different from an interference channel environment in the next scheduling time for a UE. So, a DI eNB does not change, but RB allocation situation for the UE can change, and an RB hitting ratio can change.

In a case that a downlink environment is considered, an assumption that a dominant eNB does not change until the next scheduling time of a UE can be reasonable.

So, if information included in a report message transmitted by the UE in the previous scheduling time is used, severe performance degradation due to mismatch between an interference environment in the previous scheduling time and an interference environment in the current scheduling time can occur.

Further, as well as the relatively large change per sub-frame in the interference channel, a network where a low latency backhaul exists among some macro eNBs, e.g., a partial C-RAN can be considered. Here, the low latency backhaul is almost identical to an ideal backhaul, and a low latency backhaul does not exist among all macro eNBs in the partial C-RAN. Here, a structure of the partial C-RAN can be similar to a structure of a communication system where there is a non-ideal backhaul among macro eNBs, and there is a low latency backhaul among sectors included in a macro cell or small cells and which supports an NAICS scheme.

So, in a case that change in an interference channel is relatively large per sub-frame, and a network structure is similar to a structure of a partial C-RAN, a UE and an eNB need to additionally perform the following operations when an operation of predicting and indicating an optimal Rx scheme according to an embodiment of the present disclosure is performed compared to an operation performed when a general operation of predicting and indicating an optimal Rx scheme is performed.

(1) UE Side

An operation of a UE has been described with reference to FIG. 10, and a detailed description thereof will be omitted herein.

(2) eNB Side

An eNB detects DI cells with which the eNB can cooperate using cell IDs of DI signals. The eNB detects RB allocation information of the detected DI cells with which the eNB can cooperate through a backhaul. The eNB performs an ISC operation based on the RB allocation information of the detected DI cells with which the eNB can cooperate.

The eNB determines whether there is a need for the UE to apply a non-Gaussian Rx scheme based on an interference environment according to the ISC operation. For example, the eNB determines whether there is the need for the UE to apply the non-Gaussian Rx scheme by performing a threshold value test on an RB hitting ratio of a DI signal.

Upon determining that there is the need for the UE to apply the non-Gaussian Rx scheme, the eNB informs to the UE that the UE needs to apply the non-Gaussian Rx scheme and request the UE to report interference channel information required for applying the non-Gaussian Rx scheme. The interference channel information has been described with reference to FIG. 10, so a detailed description thereof will be omitted herein.

Upon determining that there is no need for the UE to apply the non-Gaussian Rx scheme, the eNB informs to the UE that the UE does not need to apply the non-Gaussian Rx scheme and request the UE to report minimum interference channel information, i.e., a cell ID of the first DI signal, required for applying a Gaussian Rx scheme and monitoring an interference channel characteristic.

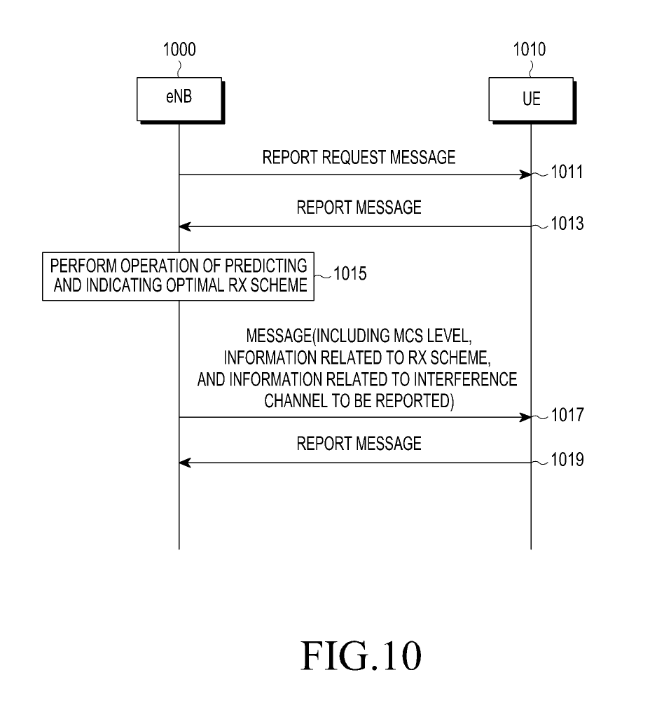

An inner structure of an eNB in a communication system according to an embodiment of the present disclosure will be described with reference to FIG. 11.

FIG. 11 schematically illustrates an inner structure of an eNB in a communication system according to an embodiment of the present disclosure.

Referring to FIG. 11, an eNB 1100 includes a transmitter 1111, a controller 1113, a receiver 1115, and a storage unit 1117.

The controller 1113 controls the overall operation of the eNB 1100. More particularly, the controller 1113 controls an operation related to an operation of controlling an operation of a UE based on an interference characteristic, e.g., an operation related to a link adaptation scheme, an ISC scheme, and an SPIORxS. The operation related to the link adaptation scheme, the ISC scheme, and the SPIORxS according to an embodiment of the present disclosure has been described with FIGS. 3 to 10, and a detailed description thereof will be omitted herein.

The transmitter 1111 transmits various signals and various messages to other entities, e.g., a UE, and/or the like included in the communication system under a control of the controller 1113. The various signals and various messages transmitted in the transmitter 1111 have been described with reference to FIGS. 3 to 10, and a detailed description thereof will be omitted herein.

The receiver 1115 receives various signals and various messages from other entities, e.g., a UE and/or the like included in the communication system under a control of the controller 1113. The various signals and various messages received in the receiver 1115 have been described with reference to FIGS. 3 to 10, and a detailed description thereof will be omitted herein.

The storage unit 1117 stores various programs, various data, and/or the like related to the operation related to the link adaptation scheme, the ISC scheme, and the SPIORxS according to an embodiment of the present disclosure under a control of the controller 1113.

The storage unit 1117 stores various signals and various messages which are received by the receiver 1115 from the other entities.

While the transmitter 1111, the controller 1113, the receiver 1115, and the storage unit 1117 are described in the eNB 1100 as separate units, it is to be understood that this is merely for convenience of description. In other words, two or more of the transmitter 1111, the controller 1113, the receiver 1115, and the storage unit 1117 can be incorporated into a single unit.

The eNB 1100 can be implemented with one processor.

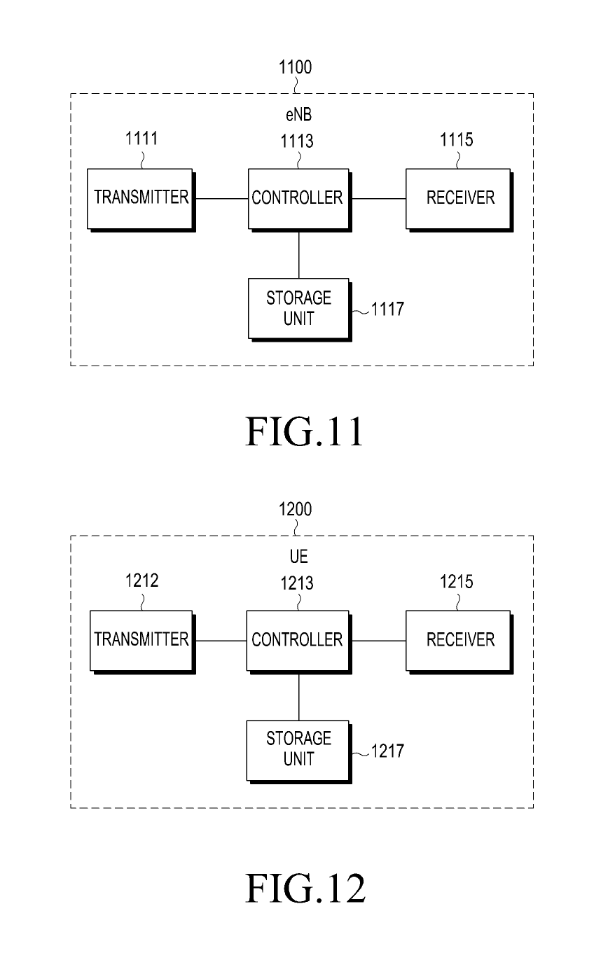

An inner structure of an eNB in a communication system according to an embodiment of the present disclosure has been described with reference to FIG. 11, and an inner structure of a UE in a communication system according to an embodiment of the present disclosure will be described with reference to FIG. 12.

FIG. 12 schematically illustrates an inner structure of a UE in a communication system according to an embodiment of the present disclosure.

Referring to FIG. 12, a UE 1200 includes a transmitter 1211, a controller 1213, a receiver 1215, and a storage unit 1217.

The controller 1213 controls the overall operation of the UE 1200. More particularly, the controller 1213 controls an operation related to an operation of controlling an operation of a UE based on an interference characteristic, e.g., an operation related to a link adaptation scheme, an ISC scheme, and an SPIORxS. The operation related to the link adaptation scheme, the ISC scheme, and the SPIORxS according to an embodiment of the present disclosure has been described with FIGS. 3 to 10, and a detailed description thereof will be omitted herein.

The transmitter 1211 transmits various signals and various messages to other entities, e.g., an eNB, and/or the like included in the communication system under a control of the controller 1213. The various signals and various messages transmitted in the transmitter 1211 have been described with reference to FIGS. 3 to 10, and a detailed description thereof will be omitted herein.

The receiver 1215 receives various signals and various messages from other entities, e.g., an eNB and/or the like included in the communication system under a control of the controller 1213. The various signals and various messages received in the receiver 1215 have been described with reference to FIGS. 3 to 10, and a detailed description thereof will be omitted herein.

The storage unit 1217 stores various programs, various data, and/or the like related to the operation related to the link adaptation scheme, the ISC scheme, and the SPIORxS according to an embodiment of the present disclosure under a control of the controller 1213.

The storage unit 1217 stores the various signals and various messages which are received by the receiver 1215 from the other entities.

While the transmitter 1211, the controller 1213, the receiver 1215, and the storage unit 1217 are described in the UE 1200 as separate units, it is to be understood that this is merely for convenience of description. In other words, two or more of the transmitter 1211, the controller 1213, the receiver 1215, and the storage unit 1217 can be incorporated into a single unit.

The UE 1200 can be implemented with one processor.

In accordance with various embodiments of the present disclosure, an operating method of a user equipment (UE) in a communication system is provided. The operating method includes transmitting, to an evolved node B (eNB) at first time, information related to channel quality, information related to a reception (Rx) scheme which the UE is able to apply, and information related to an interference environment characteristic; receiving, from the eNB, information related to a modulation and coding scheme (MCS) to be applied in the UE, information related to an Rx scheme to be applied in the UE, and information related to an interference environment characteristic which the UE needs to report; and transmitting, to the eNB at second time, information related to channel quality, information related to a reception Rx scheme which the UE is able to apply, and information related to an interference signal with maximum strength.

Preferably, a plurality of Rx schemes which are based on an interference characteristic are supported in the communication system, and the information related to the Rx scheme which the UE is able to apply is information related to at least one of the plurality of Rx schemes.

Preferably, the plurality of Rx schemes include an Rx scheme which is based on a Gaussian characteristic and an Rx scheme which is based on a non-Gaussian characteristic.

Preferably, the plurality of Rx schemes include an Rx scheme that a statistics characteristic is reflected to each of at least two resource element (RE) groups, and an RE group includes at least two REs.

Preferably, the information related to the interference environment characteristic includes at least one of a cell identifier (ID) of a dominant interference (DI) signal, an interference-to-noise ratio (INR), and a resource block (RB) hitting rate.

In accordance with various embodiments of the present disclosure, an operating method of an evolved node B (eNB) in a communication system is provided. The operating method includes receiving, from a user equipment (UE) at first time, information related to channel quality, information related to a reception (Rx) scheme which the UE is able to apply, and information related to an interference environment characteristic; determining information related to a modulation and coding scheme (MCS) to be applied in the UE, information related to an Rx scheme to be applied in the UE, and information related to an interference environment characteristic which the UE needs to report based on the received information; and transmitting, to the UE, the information related to the MCS to be applied in the UE, the information related to the Rx scheme to be applied in the UE, and the information related to the interference environment characteristic which the UE needs to report.

Preferably, a plurality of Rx schemes which are based on an interference characteristic are supported in the communication system, and the information related to the Rx scheme which the UE is able to apply is information related to at least one of the plurality of Rx schemes.

Preferably, the plurality of Rx schemes include an Rx scheme which is based on a Gaussian characteristic and an Rx scheme which is based on a non-Gaussian characteristic.

Preferably, the plurality of Rx schemes include an Rx scheme that a statistics characteristic is reflected to each of at least two resource element (RE) groups, and an RE group includes at least two REs.

Preferably, the information related to the interference environment characteristic includes at least one of a cell identifier (ID) of a dominant interference (DI) signal, an interference-to-noise ratio (INR), and a resource block (RB) hitting rate.

Preferably, the determining of the information related to the MCS to be applied in the UE, the information related to the Rx scheme to be applied in the UE, and the information related to the interference environment characteristic which the UE needs to report based on the received information comprises: determining whether a cell is a cell which is able to cooperate with the eNB based on the cell ID of the DI signal; detecting information related to RB allocation of the cell at the next scheduling time if the cell is the cell which is able to cooperate with the eNB; performing an interference signal cooperation (ISC) operation based on the information received from the UE and the information related to the RB allocation; determining whether there is a need for the UE to apply a non-Gaussian Rx scheme based on an interference environment according to the ISC operation; and determining information related to an interference environment characteristic which the UE needs to report based on the determined result.

In accordance with various embodiments of the present disclosure, a user equipment (UE) in a communication system is provided. The UE includes a transmitter configured to transmit, to an evolved node B (eNB) at first time, information related to channel quality, information related to a reception (Rx) scheme which the UE is able to apply, and information related to an interference environment characteristic; and a receiver configured to receive, from the eNB, information related to a modulation and coding scheme (MCS) to be applied in the UE, information related to an Rx scheme to be applied in the UE, and information related to an interference environment characteristic which the UE needs to report, wherein the transmitter transmits, to the eNB at second time, information related to channel quality, information related to a reception Rx scheme which the UE is able to apply, and information related to an interference signal with maximum strength.

Preferably, a plurality of Rx schemes which are based on an interference characteristic are supported in the communication system, and the information related to the Rx scheme which the UE is able to apply is information related to at least one of the plurality of Rx schemes.

Preferably, the plurality of Rx schemes include an Rx scheme which is based on a Gaussian characteristic and an Rx scheme which is based on a non-Gaussian characteristic.

Preferably, the plurality of Rx schemes include an Rx scheme that a statistics characteristic is reflected to each of at least two resource element (RE) groups, and an RE group includes at least two REs.

Preferably, the information related to the interference environment characteristic includes at least one of a cell identifier (ID) of a dominant interference (DI) signal, an interference-to-noise ratio (INR), and a resource block (RB) hitting rate.

In accordance with various embodiments of the present disclosure, an evolved node B (eNB) in a communication system is provided. The eNB includes a receiver configured to receive, from a user equipment (UE) at first time, information related to channel quality, information related to a reception (Rx) scheme which the UE is able to apply, and information related to an interference environment characteristic; a controller configured to perform an operation of determining information related to a modulation and coding scheme (MCS) to be applied in the UE, information related to an Rx scheme to be applied in the UE, and information related to an interference environment characteristic which the UE needs to report based on the received information; and a transmitter configured to transmit, to the UE, the information related to the MCS to be applied in the UE, the information related to the Rx scheme to be applied in the UE, and the information related to the interference environment characteristic which the UE needs to report.

Preferably, a plurality of Rx schemes which are based on an interference characteristic are supported in the communication system, and the information related to the Rx scheme which the UE is able to apply is information related to at least one of the plurality of Rx schemes.

Preferably, the plurality of Rx schemes include an Rx scheme which is based on a Gaussian characteristic and an Rx scheme which is based on a non-Gaussian characteristic.

Preferably, the plurality of Rx schemes include an Rx scheme that a statistics characteristic is reflected to each of at least two resource element (RE) groups, and an RE group includes at least two REs.

Preferably, the information related to the interference environment characteristic includes at least one of a cell identifier (ID) of a dominant interference (DI) signal, an interference-to-noise ratio (INR), and a resource block (RB) hitting rate.

Preferably, the operation of determining the information related to the MCS to be applied in the UE, the information related to the Rx scheme to be applied in the UE, and the information related to the interference environment characteristic which the UE needs to report based on the received information comprises: an operation of determining whether a cell is a cell which is able to cooperate with the eNB based on the cell ID of the DI signal; an operation of detecting information related to RB allocation of the cell at the next scheduling time if the cell is the cell which is able to cooperate with the eNB; an operation of performing an interference signal cooperation (ISC) operation based on the information received from the UE and the information related to the RB allocation; an operation of determining whether there is a need for the UE to apply a non-Gaussian Rx scheme based on an interference environment according to the ISC operation; and an operation of determining information related to an interference environment characteristic which the UE needs to report based on the determined result.

As is apparent from the foregoing description, an embodiment of the present disclosure enables to control an operation of a UE based on an interference characteristic in a communication system.

An embodiment of the present disclosure enables to control an operation of a UE to be suitable for a channel state based on an interference characteristic in a communication system.

An embodiment of the present disclosure enables to control an operation of a UE based on an interference characteristic thereby applying an optimal MCS level in a communication system.

An embodiment of the present disclosure enables to control an operation of a UE based on an interference characteristic thereby satisfying a target BLER in a communication system.

An embodiment of the present disclosure enables to control an operation of a UE based on an interference characteristic thereby increasing a data rate in a communication system.

An embodiment of the present disclosure enables to control an operation of a UE based on an interference characteristic thereby increasing throughput in a communication system.

Certain aspects of the present disclosure may also be embodied as computer readable code on a non-transitory computer readable recording medium. A non-transitory computer readable recording medium is any data storage device that can store data, which can be thereafter read by a computer system. Examples of the non-transitory computer readable recording medium include read only memory (ROM), random access memory (RAM), CD-ROMs, magnetic tapes, floppy disks, optical data storage devices, and carrier waves (such as data transmission through the Internet). The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

It can be appreciated that a method and apparatus according to an embodiment of the present disclosure may be implemented by hardware, software and/or a combination thereof. The software may be stored in a non-volatile storage, for example, an erasable or re-writable ROM, a memory, for example, a RAM, a memory chip, a memory device, or a memory integrated circuit (IC), or an optically or magnetically recordable non-transitory machine-readable (e.g., computer-readable), storage medium (e.g., a compact disk (CD), a digital video disc (DVD), a magnetic disk, a magnetic tape, and/or the like). A method and apparatus according to an embodiment of the present disclosure may be implemented by a computer or a mobile terminal that includes a controller and a memory, and the memory may be an example of a non-transitory machine-readable (e.g., computer-readable), storage medium suitable to store a program or programs including instructions for implementing various embodiments of the present disclosure.

The present disclosure may include a program including code for implementing the apparatus and method as defined by the appended claims, and a non-transitory machine-readable (e.g., computer-readable), storage medium storing the program. The program may be electronically transferred via any media, such as communication signals, which are transmitted through wired and/or wireless connections, and the present disclosure may include their equivalents.

An apparatus according to an embodiment of the present disclosure may receive the program from a program providing device which is connected to the apparatus via a wire or a wireless and store the program. The program providing device may include a memory for storing instructions which instruct to perform a content protect method which has been already installed, information necessary for the content protect method, and the like, a communication unit for performing a wired or a wireless communication with a graphic processing device, and a controller for transmitting a related program to a transmitting/receiving device based on a request of the graphic processing device or automatically transmitting the related program to the transmitting/receiving device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An operating method of a user equipment (UE) in a communication system, the operating method comprising:
transmitting, to an evolved node B (eNB), information related to channel quality, information related to a reception (Rx) scheme which the UE is able to apply, and information related to an interference environment characteristic; and
receiving, from the eNB, information related to a modulation and coding scheme (MCS) to be applied in the UE.

2. The operating method of claim 1, wherein a plurality of Rx schemes that are based on an interference characteristic are supported in the communication system, and the information related to the Rx scheme which the UE is able to apply is information related to at least one of the plurality of Rx schemes.

3. The operating method of claim 2, wherein the plurality of Rx schemes include an Rx scheme which is based on a Gaussian characteristic and an Rx scheme that is based on a non-Gaussian characteristic.

4. The operating method of claim 1, wherein the information related to the interference environment characteristic includes at least one of a cell identifier (ID) of a dominant interference (DI) signal, an interference-to-noise ratio (INR), and a resource block (RB) hitting rate.

5. An operating method of an evolved node B (eNB) in a communication system, the operating method comprising:
receiving, from a user equipment (UE), information related to channel quality, information related to a reception (Rx) scheme which the UE is able to apply, and information related to an interference environment characteristic;
determining information related to a modulation and coding scheme (MCS) to be applied in the UE based on the received information; and
transmitting, to the UE, information related to the MCS to be applied in the UE.

6. The operating method of claim 5, wherein a plurality of Rx schemes that are based on an interference characteristic are supported in the communication system, and the information related to the Rx scheme that the UE is able to apply is information related to at least one of the plurality of Rx schemes.

7. The operating method of claim 6, wherein the plurality of Rx schemes include a first Rx scheme that is based on a Gaussian characteristic and a second Rx scheme that is based on a non-Gaussian characteristic.

8. The operating method of claim 5, wherein the information related to the interference environment characteristic includes at least one of a cell identifier (ID) of a dominant interference (DI) signal, an interference-to-noise ratio (INR), and a resource block (RB) hitting rate.

9. The operating method of claim 8, wherein the determining of the information related to the MCS to be applied in the UE based on the received information comprising:
determining whether a cell is a cell that is able to cooperate with the eNB based on the cell ID of a dominant interference (DI) signal;
detecting information related to RB allocation of the cell in a next scheduling time of the UE if the cell is the cell that is able to cooperate with the eNB;
predicting an Rx scheme of the UE based on the information received from the UE and the information related to the RB allocation; and
performing a link adaptation operation based on the predicted Rx scheme of the UE.

10. The operating method of claim 8, wherein the determining of the information related to the MCS to be applied in the UE based on the received information comprises:
determining whether a cell is a cell that performs a interference signal cooperation (ISC) operation based on the cell ID of the DI signal;
selecting cells to perform an inter-cell interference coordination (ICIC) operation if the cell is the cell which performs the ISC operation;
predicting an Rx scheme to be applied in the UE based on the information received from the UE; and
performing an ISC operation based on the predicted Rx scheme of the UE.

11. A user equipment (UE) in a communication system, the UE comprising:
a transmitter configured to transmit, to an evolved node B (eNB), information related to channel quality, information related to a reception (Rx) scheme that the UE is able to apply, and information related to an interference environment characteristic; and
a receiver configured to receive, from the eNB, information related to a modulation and coding scheme (MCS) to be applied in the UE.

12. The UE of claim 11, wherein a plurality of Rx schemes that are based on an interference characteristic are supported in the communication system, and the information related to the Rx scheme that the UE is able to apply is information related to at least one of the plurality of Rx schemes.

13. The UE of claim 12, wherein the plurality of Rx schemes include a first Rx scheme that is based on a Gaussian characteristic and a second Rx scheme that is based on a non-Gaussian characteristic.

14. The UE of claim 11, wherein the information related to the interference environment characteristic includes at least one of a cell identifier (ID) of a dominant interference (DI) signal, an interference-to-noise ratio (INR), and a resource block (RB) hitting rate.

15. An evolved node B (eNB) in a communication system, the eNB comprising:
a receiver configured to receive, from a user equipment (UE), information related to channel quality, information related to a reception (Rx) scheme which the UE is able to apply, and information related to an interference environment characteristic;
a controller configured to determine information related to a modulation and coding scheme (MCS) to be applied in the UE based on the received information; and
a transmitter configured to transmit, to the UE, information related to the MCS to be applied in the UE.

16. The eNB of claim 15, wherein a plurality of Rx schemes that are based on an interference characteristic are supported in the communication system, and the information related to the Rx scheme that the UE is able to apply is information related to at least one of the plurality of Rx schemes.

17. The eNB of claim 16, wherein the plurality of Rx schemes include a first Rx scheme that is based on a Gaussian characteristic and a second Rx scheme that is based on a non-Gaussian characteristic.

18. The eNB of claim 15, wherein the information related to the interference environment characteristic includes at least one of a cell identifier (ID) of a dominant interference (DI) signal, an interference-to-noise ratio (INR), or a resource block (RB) hitting rate.

19. The eNB of claim 18, wherein the controller is further configured to:
determine whether a cell is a cell which is able to cooperate with the eNB based on the cell ID of the DI signal;
detect information related to RB allocation of the cell in a next scheduling time of the UE if the cell is the cell which is able to cooperate with the eNB;
predict an Rx scheme of the UE based on the information received from the UE and the information related to the RB allocation; and
perform a link adaptation operation based on the predicted Rx scheme of the UE.

20. The eNB of claim 18, wherein the controller is further configured to:
determine whether a cell is a cell which performs a interference signal cooperation (ISC) operation based on the cell ID of the DI signal;
select cells which will perform an inter-cell interference coordination (ICIC) operation if the cell is the cell which performs the ISC operation;
predict an Rx scheme to be applied in the UE based on the information received from the UE; and
perform an ISC operation based on the predicted Rx scheme of the UE.
